(19) United States
(12) Patent Application Publication
(10) Pub. No.: US 2008/0126478 A1
(43) Pub. Date: May 29, 2008

(54) Information Collection System

(75) Inventors: Mark William James Ferguson, Derbyshire (GB); Jonathan Burr, Newcastle Upon Tyne (GB); Peter Cridland, Manchester (GB); Jonathan Duncan, Glasgow (GB); Lee Humphreys, Newcastle Upon Tyne (GB)

Correspondence Address: MORRISON & FOERSTER LLP, 755 PAGE MILL RD, PALO ALTO, CA, 94304-1018, US

(73) Assignee: RENOVO LIMITED

(21) Appl. No.: 11/792,760

(22) PCT Filed: Dec. 14, 2005
(86) PCT No.: PCT/GB05/04787

§ 371 Date: Jan. 7, 2008

Related U.S. Application Data
(60) Provisional application No. 60/637,266, filed on Dec. 17, 2004.

(30) Foreign Application Priority Data
Dec. 16, 2004 (GB) 0427642.4

(51) Int. Cl. G06F 15/16; G06F 21/20; G06F 3/048

(52) U.S. Cl. 709/203; 726/5; 715/733

(57) ABSTRACT

A method and system of collecting information relating to an image. The method comprises presenting the image from a first computer. A plurality of second computers is connected to the first computer, and these second computers generate a plurality of data items relating to said image. Each of said data items are transmitted from a respective one of the plurality of second computers to the first computer, and each data item is received at the first computer. Said data items are associated with an identifier identifying said image, and each data item is stored together with the associated identifier in a database.

The present invention relates to a method and apparatus for collecting descriptive information relating to an image.

It is well known that methods are required to determine the effectiveness of medicaments. Typically, a new medicament is initially tested on animals before being tested on humans. Tests on humans often involve dividing a group of humans suffering from a condition which it is desired to treat into two sub groups. A first sub group is provided with a placebo (i.e. a substance having no therapeutic affect), and a second group is provided with the medicament, the effectiveness of which is to be tested. By comparing symptoms within the first and second sub groups, the effectiveness of the medicament as compared to the placebo can be determined.

Methods of measuring medicament effectiveness are highly dependent upon the condition which is to be treated. For some conditions an objective measure of effectiveness can easily be derived. For example, if a medicament is intended to reduce cholesterol levels, taking cholesterol readings of the patients in the first and second sub groups will determine the effectiveness of the medicament. In other cases such an objective measure cannot easily be derived. One example of such a case is an assessment of the effectiveness of a medicament for promoting wound healing and/or reducing scarring, which is at least partially subjective.

The term “wound” is exemplified by, but not limited to, injuries to the skin. Other types of wound can involve damage, injury or trauma to an internal tissue or organ such as the lung, kidney, heart, gut, tendons or liver.

The response to wounding is common throughout all adult mammals. It follows the same pattern, and leads to the same result, formation of a scar. Many different processes are at work during the healing response, and much research has been conducted into discovering what mediates these processes, and how they interact with each other to produce the final outcome.

The healing response arises as the evolutionary solution to the biological imperative to prevent the death of a wounded animal. Thus, to overcome the risk of mortality due to infection or blood loss, the body reacts rapidly to repair the damaged area, rather than attempt to regenerate the damaged tissue.

A scar may be defined as the structure produced as a result of the reparative response. Since the injured tissue is not regenerated to attain the same tissue architecture present before wounding a scar may be identified by virtue of its abnormal morphology as compared to unwounded tissue. Scars are composed of connective tissue deposited during the healing process. A scar may comprise connective tissue that has an abnormal organisation (as seen in scars of the skin) and/or connective tissue that is present in an abnormally increased amount (as seen in scars of the central nervous system). Most scars consist of both abnormally organised and excess connective tissue.

The abnormal structure of scars may be observed with reference to both their internal structure (which may be determined by means of microscopic analysis) and their external appearance (which may be assessed macroscopically).

Extracellular matrix (ECM) molecules comprise the major structural component of both unwounded and scarred skin. In unwounded skin these molecules form fibres that have a characteristic random arrangement that is commonly referred to as a “basket-weave”. In general the fibres observed within unwounded skin are of larger diameter than those seen in scars. Fibres in scars also exhibit a marked degree of alignment with each other as compared to the fibres of unwounded skin. Both the size and arrangement of ECM may contribute to scars' altered mechanical properties, most notably increased stiffness, when compared with normal, unwounded skin.

Viewed macroscopically, scars may be depressed below the surface of the surrounding tissue, or elevated above the surface of the undamaged skin. Scars may be relatively darker coloured than the unwounded tissue (hyperpigmentation) or may have a paler colour (hypopigmentation) than their surroundings. Scars may also be redder than the surrounding skin. Either hyperpigmented or hypopigmented or redder scars constitute a readily apparent cosmetic defect. It has been shown that the cosmetic appearance of a scar is one of the major factors contributing to the psychological impact of wounds upon the sufferer, and that these effects can remain long after the wound itself has healed.

Scars may also have deleterious physical effects upon the sufferer. These effects typically arise as a result of the mechanical differences between scars and unwounded skin. The abnormal structure and composition of scars mean that they are typically less flexible than normal skin. As a result scars may be responsible for impairment of normal function (such as in the case of scars covering joints which may restrict the possible range of movement) and may retard normal growth if present from an early age.

The effects outlined above may all arise as a result of the normal progression of the wound healing response. There are, however, many ways in which this response may be abnormally altered; and these are frequently associated with even more damaging results.

One way in which the healing response may be altered is through the production of abnormal excessive scarring. Hypertrophic scars represent a severe form of scarring, and hypertrophic scars have marked adverse effects on the sufferer. Hypertrophic scars are elevated above the normal surface of the skin and contain excessive collagen arranged in an abnormal pattern. As a result such scars are often associated with a marked loss of normal mechanical function. This may be exacerbated by the tendency of hypertrophic scars to undergo contraction after their formation, an activity normally ascribed to their abnormal expression of muscle-related proteins (particularly smooth-muscle actin). Children suffer from an increased likelihood of hypertrophic scar formation, particularly as a result of burn injuries.

Keloids are another common form of pathological scarring. Keloid scars are not only elevated above the surface of the skin but also extend beyond the boundaries of the original injury. Keloids contain excessive connective tissue that is organised in an abnormal fashion, normally manifested as whirls of collagenous tissue. The causes of keloid formation are open to conjecture, but it is generally recognised that some individuals have a genetic predisposition to their formation. Both hypertrophic scars and keloids are particularly common in Afro-Caribbean and Mongoloid races.

Whilst the above considerations apply primarily to the effects of wound healing in man, it will be appreciated that the wound healing response, as well as its disadvantages and potential abnormalities, is conserved between most species of animals. Thus the problems outlined above are also applicable to non-human animals, and particularly veterinary or domestic animals (e.g. horses, cattle, dogs, cats etc). By way of example, it is well known that adhesions resulting from the inappropriate healing of abdominal wounds constitute a major reason for the veterinary destruction of horses (particularly race horses). Similarly the tendons and ligaments of domestic or veterinary animals are also frequently subject to injury, and healing of these injuries may also lead to scarring associated with increased animal mortality.

From the preceding discussion, it will be appreciated that there is a need for a method of measuring the effectiveness of wound healing and scar reduction medicaments. Given that some of the disadvantageous effects of scars are psychological there is no objective chemical or biochemical test which can properly determine the effectiveness of a scar reduction therapy in overcoming such psychological effects. Indeed, an important indicator in assessing scar reduction is the subjective response to scars which have been treated with the medicament as compared to scars which have not been treated with that medicament. This problem is complicated by the fact that scar reduction therapies are normally tested on volunteers who are wounded in a clinical test and then have the medicament applied to them. Therefore, the scar which is being improved is often one created for the purposes of the clinical test.

It is known to use visual analogue scoring to measure severity of scarring. This is achieved by showing an assessor a plurality of scars and asking that they indicate on a scale extending from a low value to a high value the severity of the scar. Marks marked on the visual scale are then converted to scores to determine the relative perceived severity of scarring and by using this technique with images of scars which have or have not been subjected to the medicament a measure of medicament effectiveness can be derived.

Although visual analogue scoring does provide valuable data it will be appreciated that implementing a visual analogue scoring system is not straightforward, particularly, given that the information to be collected must be collected in a regulatory compliant fashion so as to satisfy various drug approval agents such as the Food and Drug Administration (FDA) in the United States. Similar problems occur when other metrics are used to obtain data relating to images.

Where the information is to be collected electronically, for example, using computers, any computer system must satisfy the requirements of 21 CFR Part 11, set out in Part II of the US Federal register and entitled “Electronic Records; Electronic Signatures; Final Rule, Electronic Submissions; Establishment of Public Docket; Notice”, Department of Health and Human Services, Food and Drug Administration, 20 Mar. 1997, the contents of which are herein incorporated by reference. Heretofore there has been no electronic system suitable for collection of data relating to images which satisfies the onerous requirements of 21 CFR Part 11.

It is an object of the present invention to obviate or mitigate at least some of the problems outlined above.

Embodiments of the present invention will now be described, by way of example, with reference to the accompanying drawings, in which:

According to the present invention, there is provided a method and apparatus of collecting information relating to an image. The method comprises presenting the image, receiving a plurality of data items relating to said image, each of said data items being received from one of a plurality of computers, associating said data items with an identifier identifying said image, and storing each data item together with the associated identifier in a data repository.

Thus the invention allows an image to be presented and data relating to that image to be collected from a plurality of assessors using a plurality of computers. The data is then stored in a data repository. For example, the received data items may each represent an assessor's subjective response to the presented image.

In preferred embodiments of the present invention the data repository is a database, and more preferably a structured database handled by a database management system. For example, the data repository may be a relational database implemented using the Structured Query language and managed by a conventional database management system. The database may alternatively by an object oriented database. In some embodiments the data repository is not a database managed by a database management system, but instead a file or collection of files where collected data can be stored in a predetermined manner.

The plurality of computers may transmit data to the server in response to a request. The request may be transmitted to the plurality of computers from the server. The request may be transmitted at a first time, and the plurality of data items may be received within a predetermined time period beginning at said first time. The predetermined time may be specified by said request. The request may be configured to cause the plurality of computers to display a user interface configured to receive input resulting in creation of a data item.

In some embodiments of the present invention, the image is an image of human or animal skin, and the skin may include a scar. In such circumstances the received data may provide information indicating perceived severity of scarring within the displayed image. Therefore if data is collected for a plurality of different images, each showing a different scar, and only some of these scars have been treated using a particular medicament, the invention allows information to be collected which allows the effectiveness of the medicament to be assessed. It should be noted that the collected information represents a subjective assessment of the degree of scarring, and can therefore take into account likely psychological effects of the scarring.

Each of the data items may comprise a real number within a predetermined range and the real number may represent perceived severity of said scar. The real number may be generated using a visual analogue scoring method. More specifically, assessors may be presented with a user interface comprising a scale, and input data indicating user input of a point on said scale may then be received. The input of a point on said scale to said may then be converted into a real number.

The converting described above can be carried out in any convenient way. For example, a first real number value may be defined to correspond to a first end of said scale, and a second real number value may be defined to correspond to a second end of scale. By computing a distance from said first end of said scale to said point, this distance can be converted to a real value on the basis of the distance between said first and second ends, and said first and second real number values.

The present invention also allows data to be collected which indicates a comparison between a plurality of images, and each image of the plurality of images may be an image of a scar. Here, each of the data items may indicate whether there is a perceived difference between the severity of said scars. If one of said data items indicates that there is a perceived difference between the severity of said scars, said one data item may further indicate which of said images shows least severe scarring. The plurality of images may be a pair of images.

A user interface may be displayed on a display device, and the user interface may include a plurality of user selectable buttons. Input data indicative of user selection of one of said buttons may then be received. More specifically, where the plurality of images is a pair of images, said user interface may comprise three buttons. A first button may be selectable to indicate that a first image of said pair of images shows less severe scarring, a second button may be selectable to indicate that a second image of said pair of images shows less severe scarring and a third button may be selectable to indicate that said first and second images show scarring of similar severity.

The method may further comprise providing computer program code to each of said plurality of computers, and the program code may be executable at one of said plurality of computers to generate one of said data items. In this way, different assessment data may be collected depending upon the computer program code which is provided. Thus, the invention allows the assessment data which is to be collected to be easily modified. The computer program code may include computer program code executable to provide an interface to control data collection to generate one of said data items.

If input data indicative of user selection of said first button or said second button is received, a further user interface may then be displayed. This further user interface may be configured to receive input data indicative of a degree of difference between severity of scarring shown in said first and second images of said pair of images. More specifically, the further user interface may present a pair of buttons, a first button indicating that said difference is slight, and a second button indicating that said difference is marked.

Data defining a plurality of users may be stored. These data may include a username and password for each of said plurality of users. Data indicating a number of user logons which are required to allow information collection may also be stored, and the required number of logons may be determined from user input data.

The method may further comprise, before presentation of said image, receiving a logon request, said logon request being received from one of said plurality of computers, and including a username and password, validating said received logon request using said data defining a plurality of users and generating data indicating a logon if but only if said validation is successful. Before presentation of said image, the method may comprise receiving at least as many logon requests as said required number of logons, and generating data indicating said required number of logons. A logon request may be denied if said specified number of users are logged on.

The image may be presented for not longer than a maximum image presentation time, and the maximum image presentation time may be determined by user input data. The image may be presented either for the maximum image presentation time or until a data item associated with each of said logons has been received.

If a data item associated with one of said logons has not been received when said maximum presentation time is reached, data indicating each of said logons for which data has not been received, and said image may be generated. Additionally, the image may be represented, and a data item associated with each of said indicated logons may be received.

The image may be presented using a projector which projects the image onto a screen visible by operators of the plurality of computers. Alternatively, the image may be presented by displaying the image on a display device such as a plasma screen visible by operators of the plurality of computers. Each of said plurality of data items may be received using the TCP/IP protocol or any other suitable protocol such as for example NetBEUI or IPX.

Storing each data item with its associated identifier in a database may further comprise storing with each data item a date and time at which it was received, and/or storing with each data item data indicating a user logon at the computer providing said data item. Each of said data items together with the associated identifier may be transmitted to a remote database server.

The method may comprise sequentially presenting a plurality of images, and receiving a plurality of data items relating to each of said plurality of images. The images may be presented in a random or pseudo-random order. Some of said plurality of presented images may be identical.

A report indicating user logons for which data items have not been received may be generated and this report may indicate images for which a data item has not been received.

The invention as described above can be implemented by suitably programming a computer. The invention therefore also provides a data carrier carrying computer readable instructions configured to cause a computer to carry out the method described in the preceding paragraphs.

The invention also provides a computer apparatus comprising a program memory storing processor readable instructions, and a processor configured to read and execute instructions stored in said program memory. The processor readable instructions comprise instructions controlling the processor to carry out the method described above.

The invention may be implemented in the context of a distributed system, and accordingly the invention further provides a method and apparatus for collecting information relating to an image. The method comprises presenting the image from a first computer, generating a plurality of data items relating to said image each of said data items being generated by one of a plurality of second computers connected to said first computer, transmitting each of said data items from a respective one of the plurality of second computers to the first computer, receiving each of said data items at the first computer, associating said data items with an identifier identifying said image, and storing each data item together with the associated identifier in a database.

The present invention further provides a system for collecting information relating to an image, the system comprises a first computer in communication with a plurality of second computers. The first computer is configured to present the image. Each of the second computers is configured to capture a data item relating to the image and to transmit said data item to said first computer. The first computer is configured to receive said data items, to associate an identifier identifying said image with each data item, and to output each data item together with the associated identifier to a database.

The system may further comprise a database server connected to said first computer. The first computer may be further configured to transmit said data items together with the associated identifier to the database server. Communication between said first computer and said database server may be a wired connection or a wireless connection. Similarly, communication between the first computer and the second computers may be a wired or wireless connection. For example, if a wireless connection is used, the first computer and the second computers may be connected together using a wireless local area network (WLAN)

The invention also provides a method and apparatus for collecting assessment data relating to displayed data. The method comprises providing computer program code to a plurality of second computers, said computer program code being executable at each of said second computers to control collection of said assessment data, presenting said displayed data, and receiving assessment data relating to said displayed data from each of said plurality of second computers, said assessment data being generated at each of said second computers by execution of said computer program code.

Thus, a method is provided in which the assessment data to be collected is specified by a first computer to the plurality of second computers. Thus, if different assessment data is to be collected, this can be achieved by simply providing different computer program code to the first computer and arranging that this is provided to the second computers as and when appropriate.

The displayed data may be image data. The computer program code may be executable to display a user interface configured to receive user input to generate one of said data items. The method may further comprise storing a plurality of computer programs, each computer program being defined by respective computer program code, and receiving user input indicating selection of one of said computer programs. Providing computer program code may then comprise providing computer program code defining said selected computer program.

It will be appreciated that various features of the invention described above in the context of one aspect of the invention can be applied to the other described aspects of the invention.

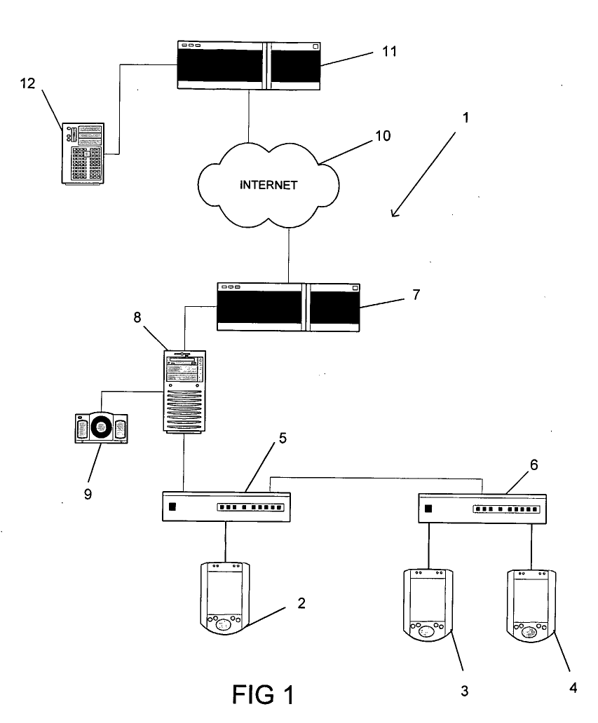

FIG. 1 is a schematic illustration of a computer network used to implement embodiments of the present invention;

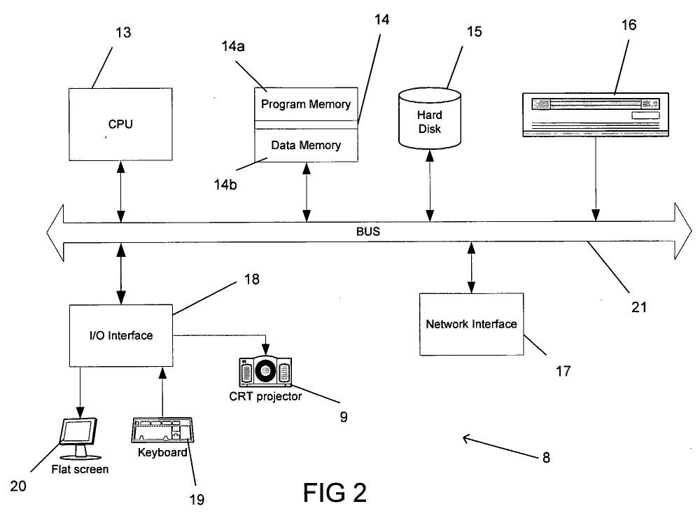

FIG. 2 is a schematic illustration showing a controller PC of FIG. 1 in further detail;

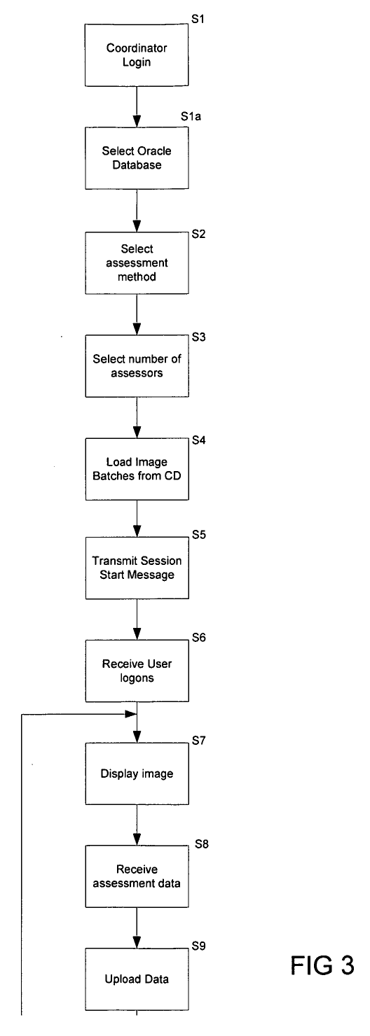

FIG. 3 is a flow chart showing an overview of operation of an embodiment of the present invention;

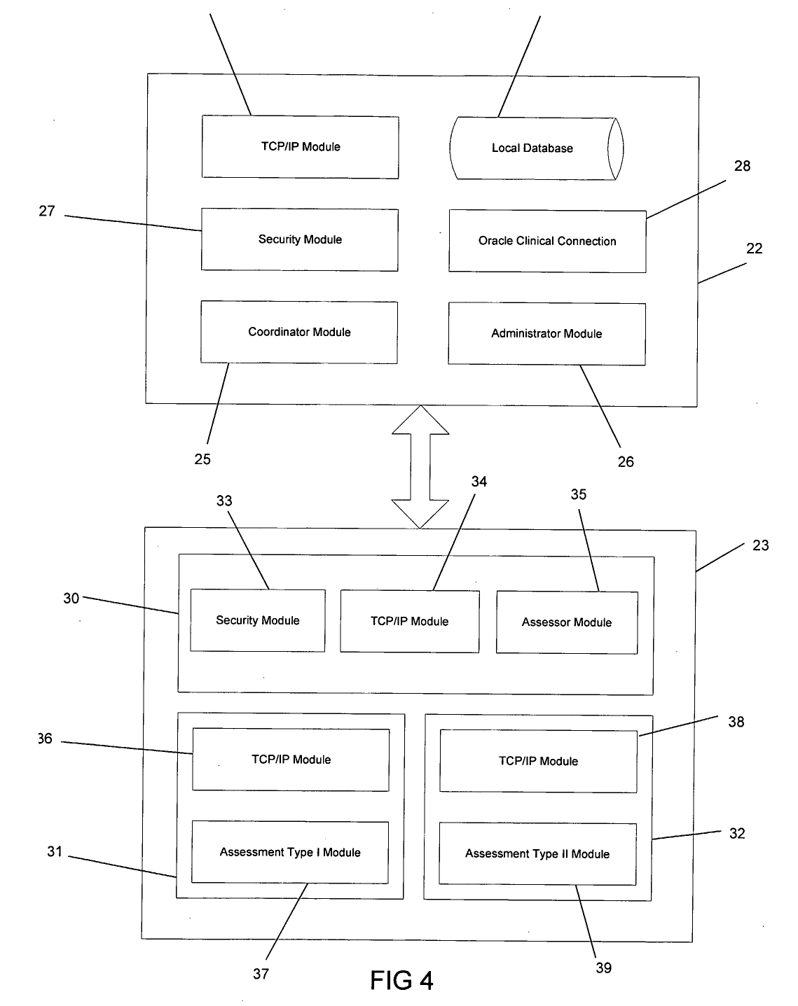

FIG. 4 is a schematic illustration of the structure of computer software used to implement the present invention;

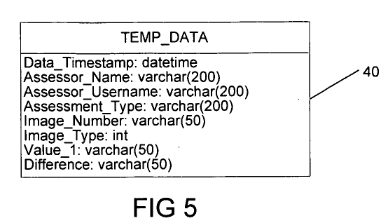

FIGS. 5 to 7 are illustrations of tables in a database stored on the controller PC of FIG. 1;

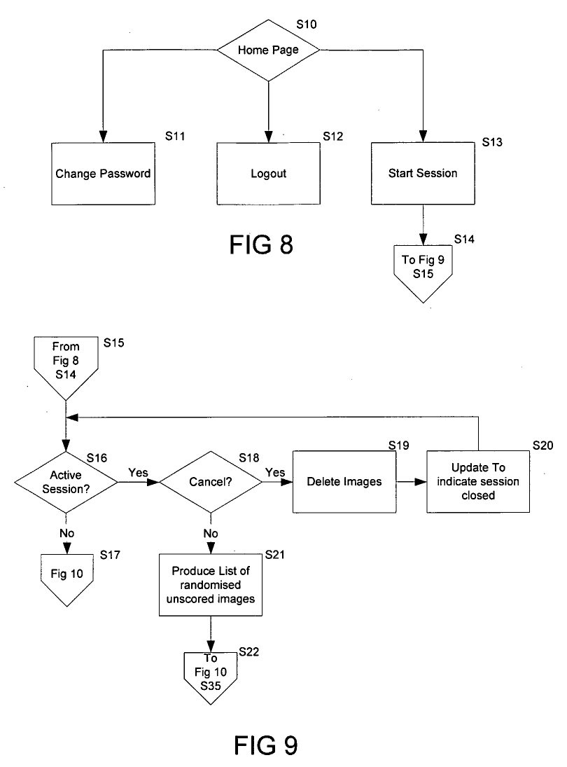

FIG. 8 is a flow chart illustrating operation of a graphical user interface (GUI) presented to a coordinator operating the controller PC of FIG. 2;

FIG. 9 is a flow chart illustrating the process for beginning an assessment session using the controller PC of FIG. 2;

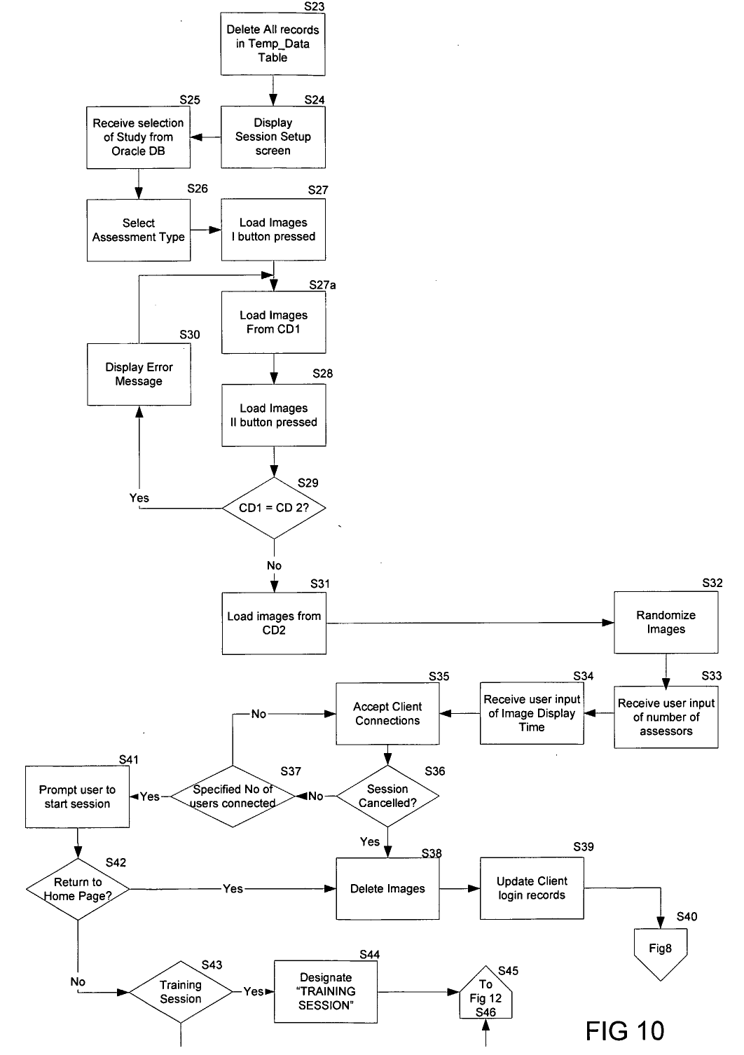

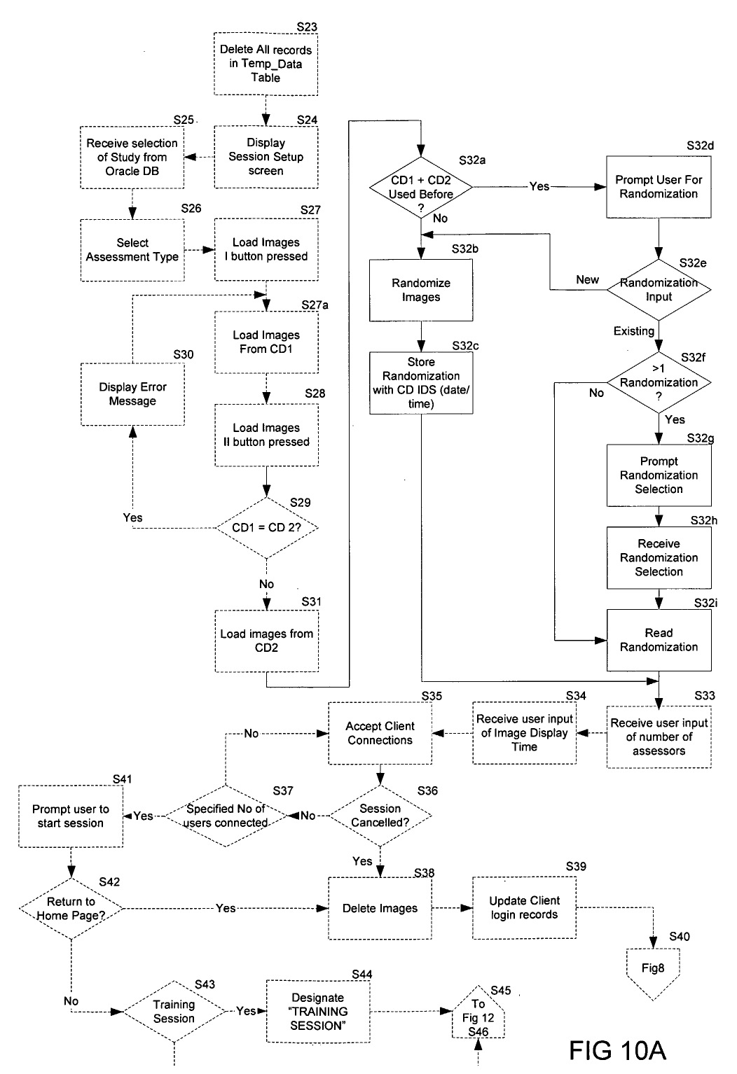

FIGS. 10 and 10A are flow charts illustrating processes for setting up an assessment session using the controller PC of FIG. 2;

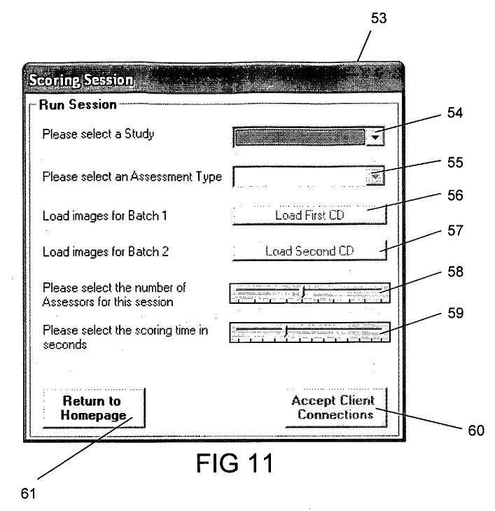

FIG. 11 is a screen shot of the GUI presented to the coordinator by the controller PC of FIG. 2;

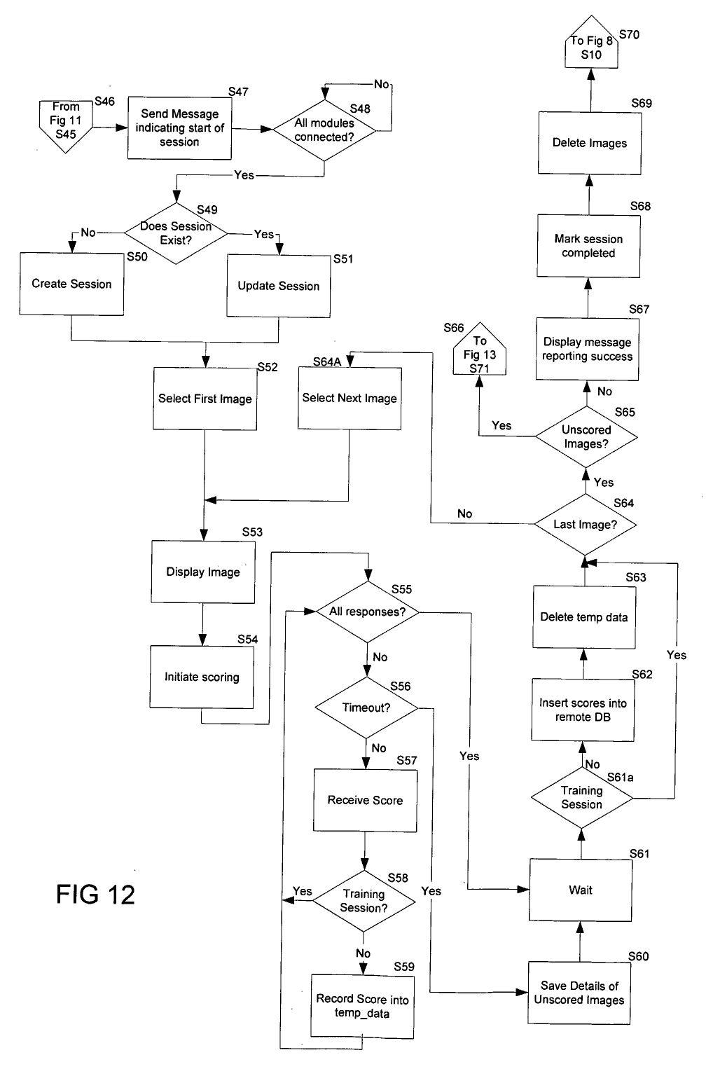

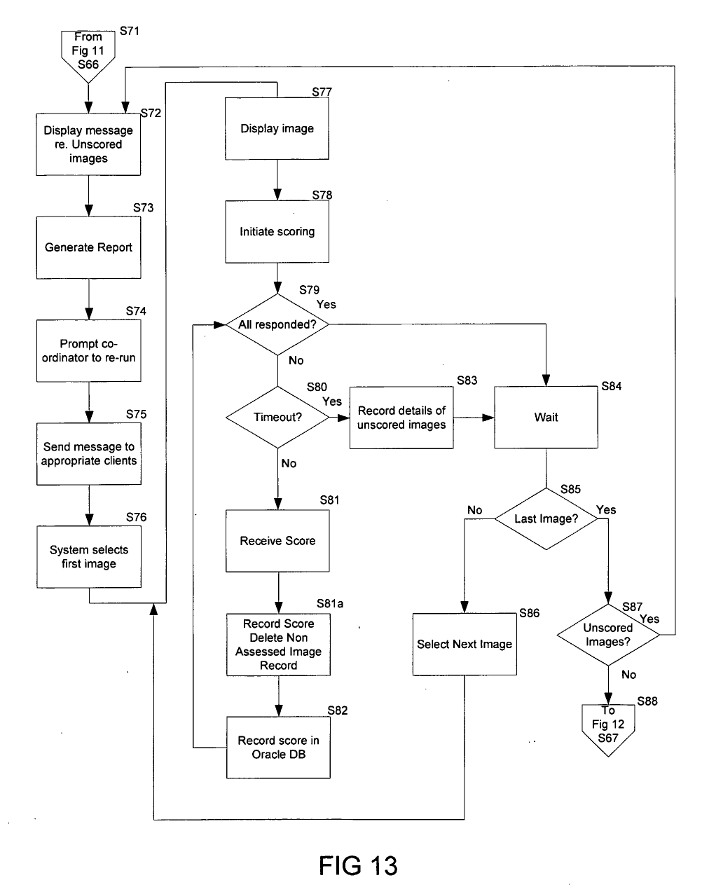

FIG. 12 is a flow chart illustrating a process for running an assessment section using the controller PC of FIG. 2;

FIG. 13 is a flow chart illustrating a process for handling missing data in the process of FIG. 12;

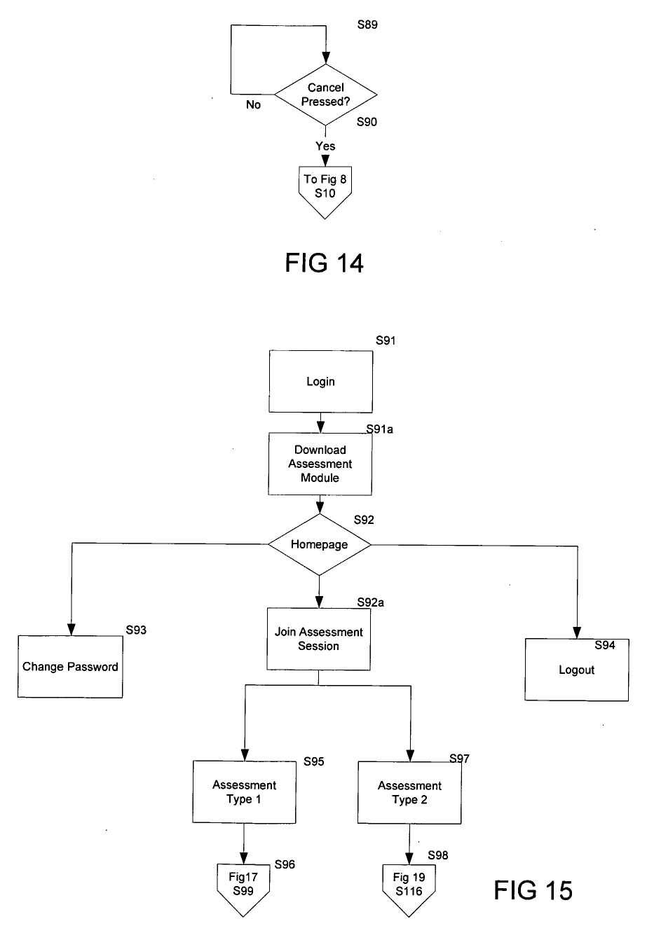

FIG. 14 is a flow chart showing how a user may cancel an assessment session operated as illustrated in FIG. 12;

FIG. 15 is a flow chart illustrating options provided to an assessor using the system of FIG. 1;

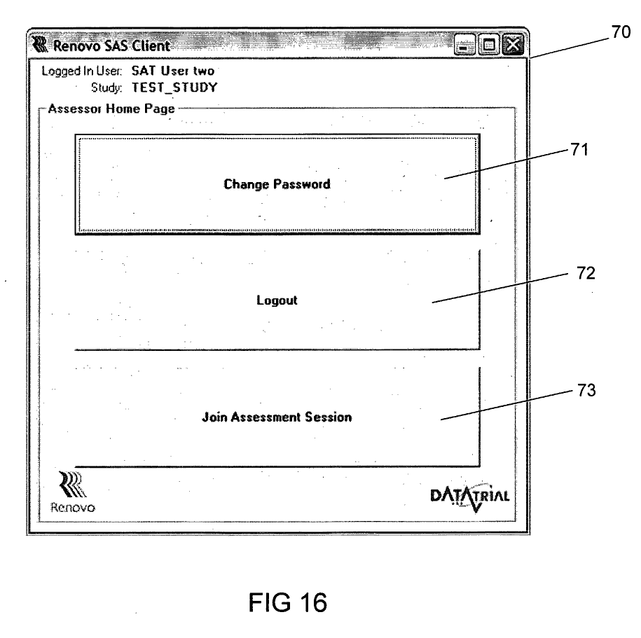

FIG. 16 is a screen shot of a GUI used by the assessor to implement that which is illustrated in FIG. 15;

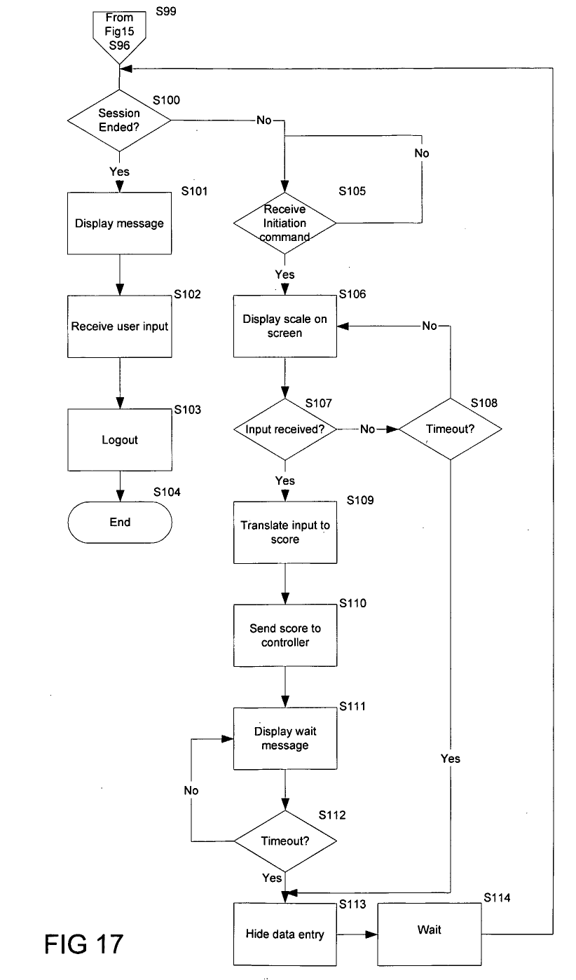

FIG. 17 is a flow chart illustrating a first image assessment method used by an assessor;

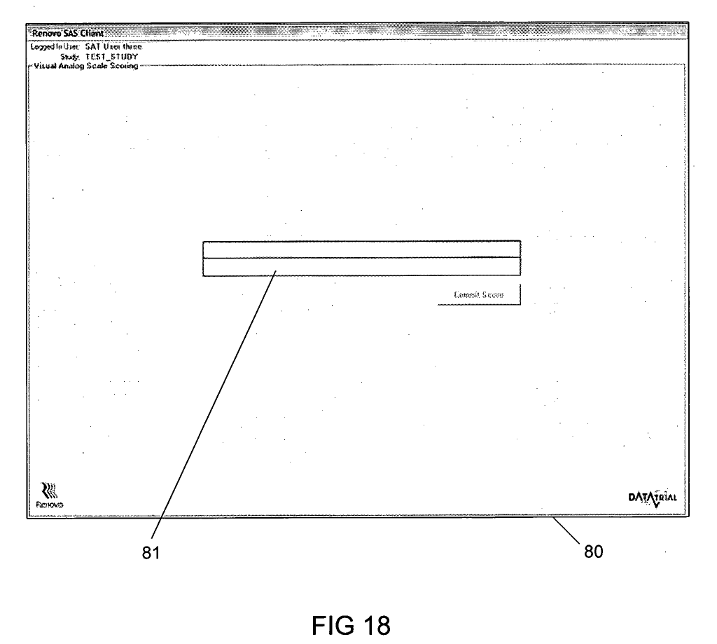

FIG. 18 is a screen shot of a GUI used to carry out image assessment as illustrated in FIG. 17;

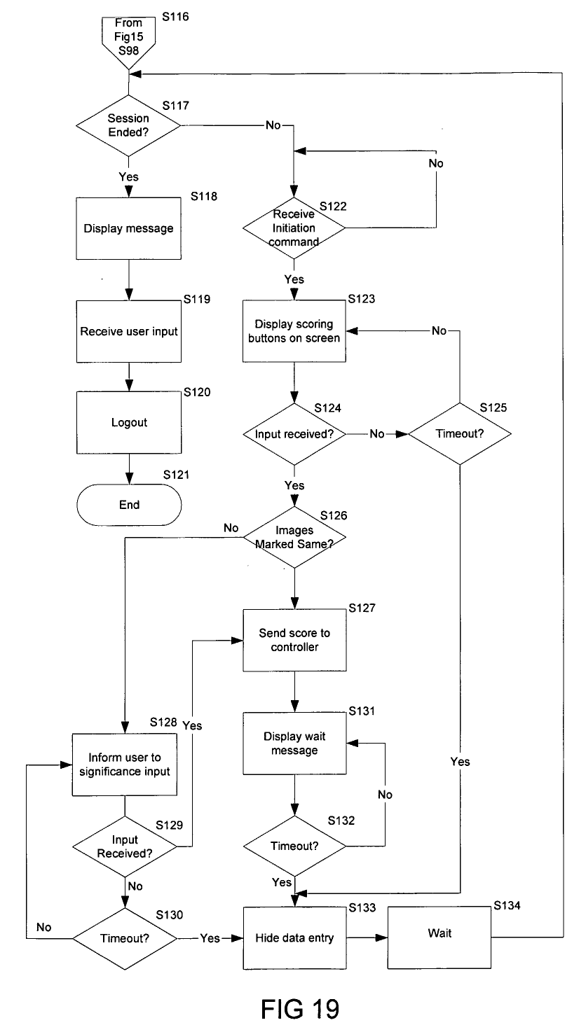

FIG. 19 is a flow chart illustrating an alternative image assessment method;

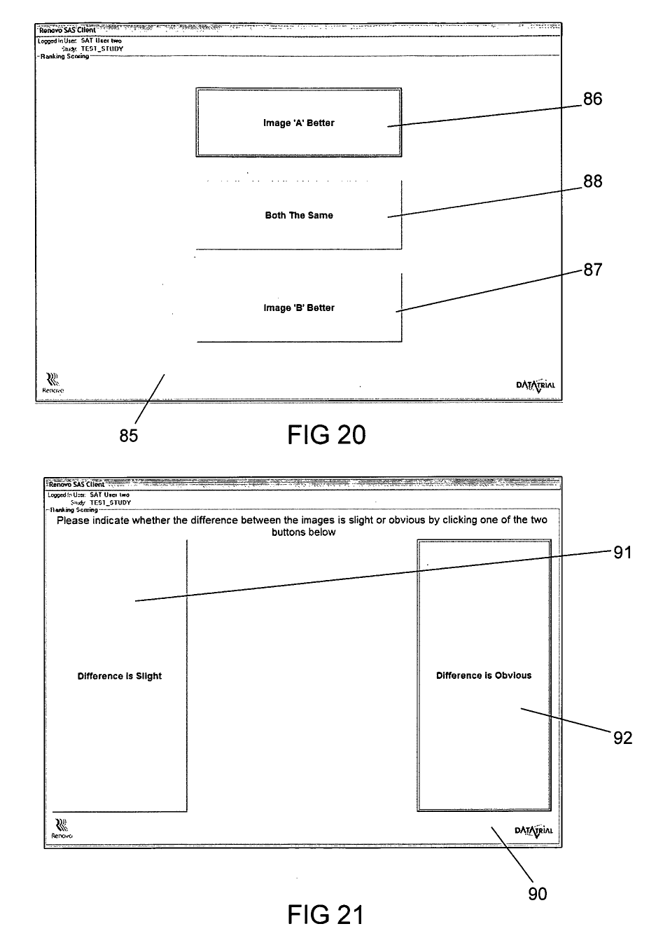

FIGS. 20 and 21 are screen shots of a GUI used to carry out image assessment as illustrated in FIG. 19;

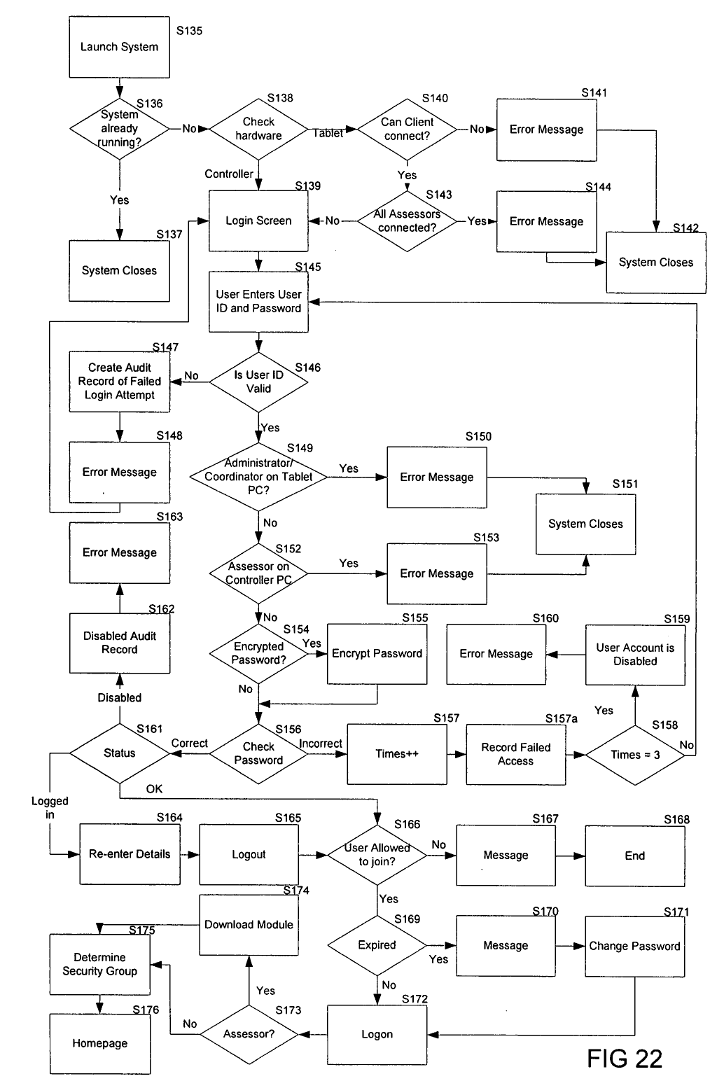

FIG. 22 is a flow chart illustrating a login process used in embodiments of the present invention;

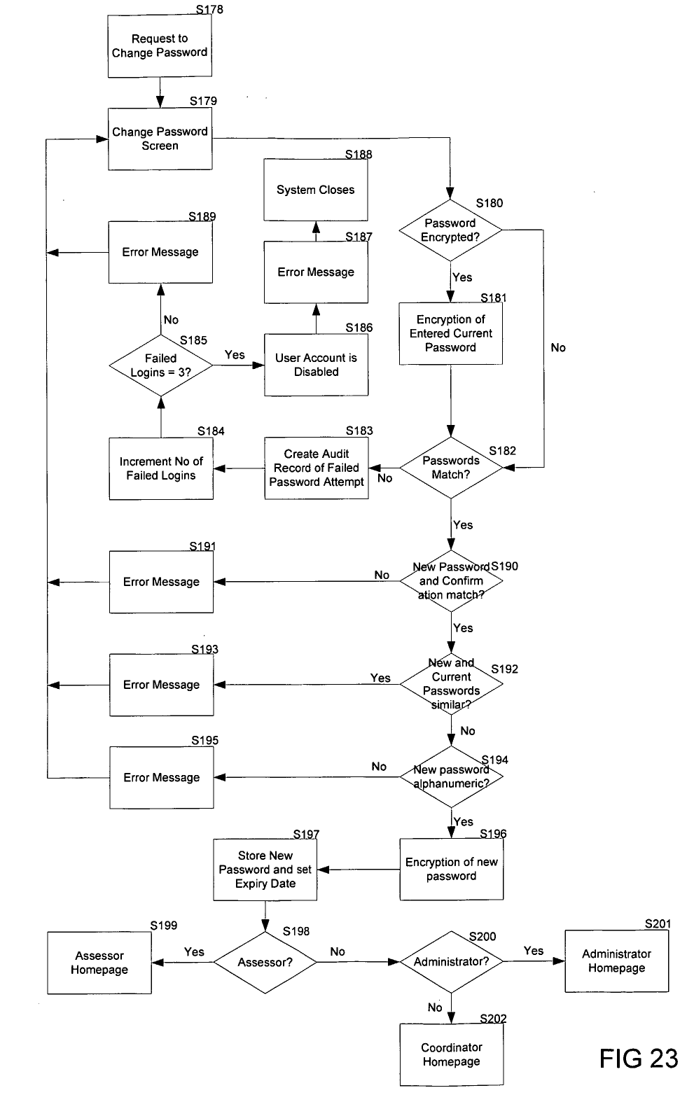

FIG. 23 is a flow chart illustrating a process for changing a password in embodiments of the present invention;

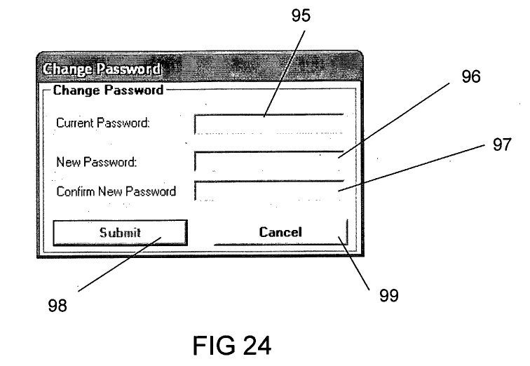

FIG. 24 is a schematic illustration of a dialog used to change a password in the process of FIG. 24;

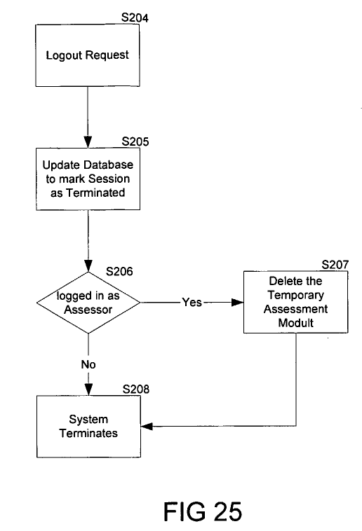

FIG. 25 is a flow chart illustrating a log out process used in embodiments of the present invention;

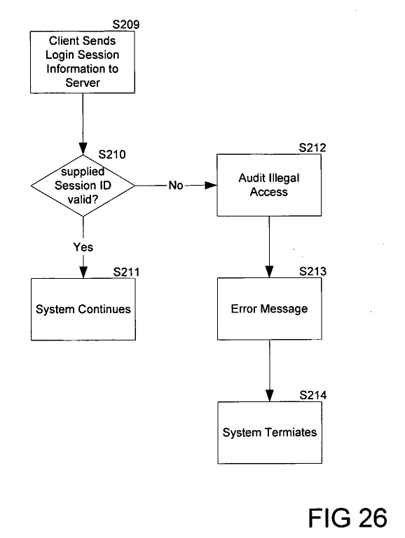

FIG. 26 is a flow chart showing a session validation process used in embodiments of the present invention;

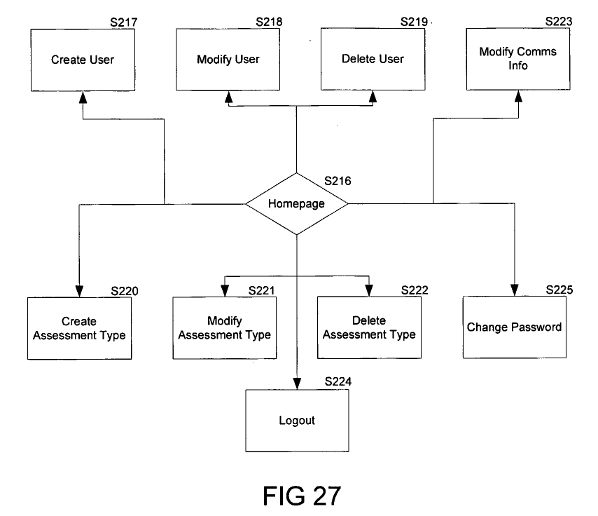

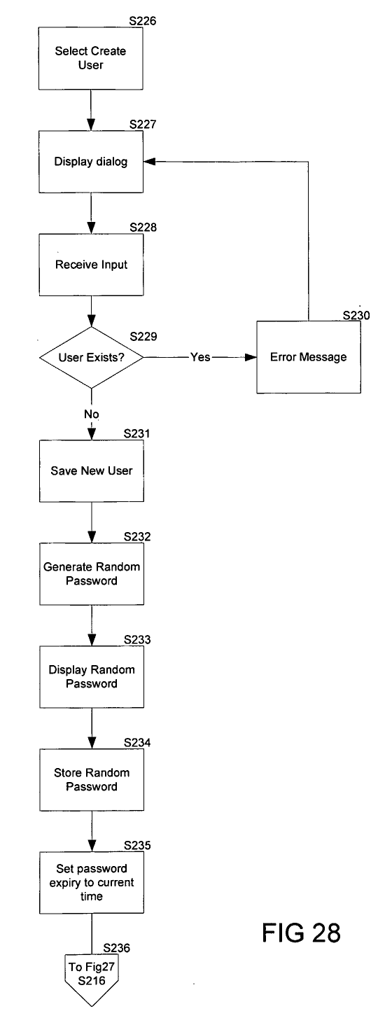

FIG. 27 is a flow chart illustrating options presented to an administrator using the controller PC of FIG. 2;

FIG. 28 is a flow chart illustrating a process used by the administrator to create a new user;

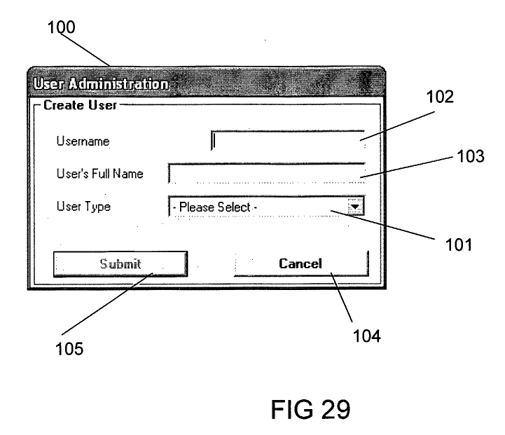

FIG. 29 is a schematic illustration of a dialog used to create a new user in the process of FIG. 28;

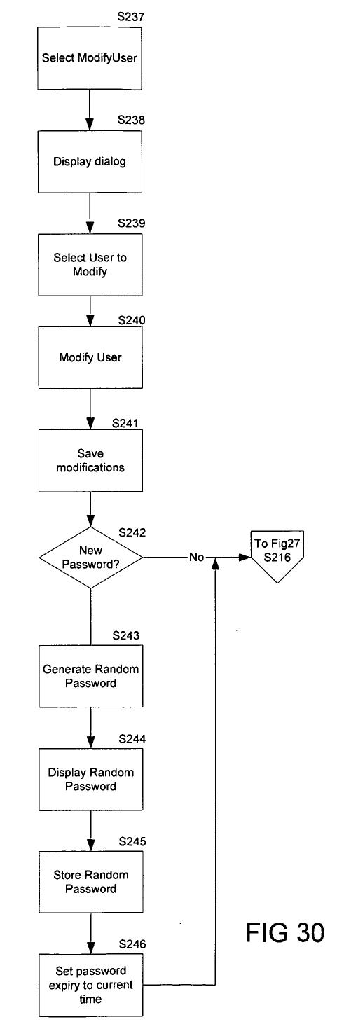

FIG. 30 is a flow chart illustrating a process used by the administrator to modify user details;

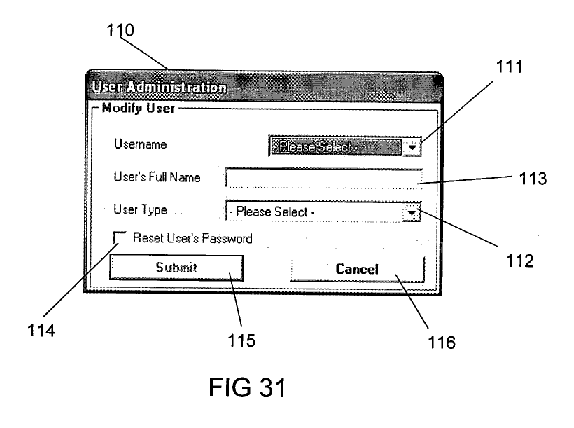

FIG. 31 is a schematic illustration of a dialog used to modify user details in the process of FIG. 30;

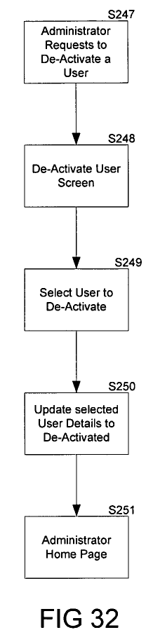

FIG. 32 is a flow chart illustrating a process used by the administrator to disable a user;

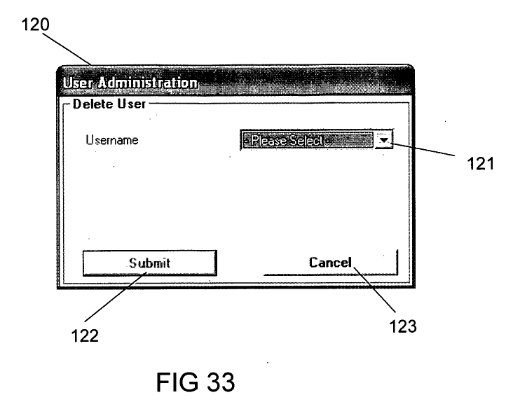

FIG. 33 is a schematic illustration of a dialog used to delete a user in the process of FIG. 32;

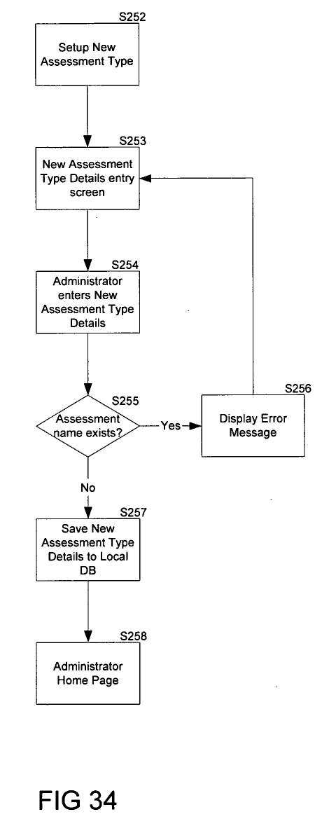

FIG. 34 is a flow chart illustrating a process used by the administrator to create a new assessment type;

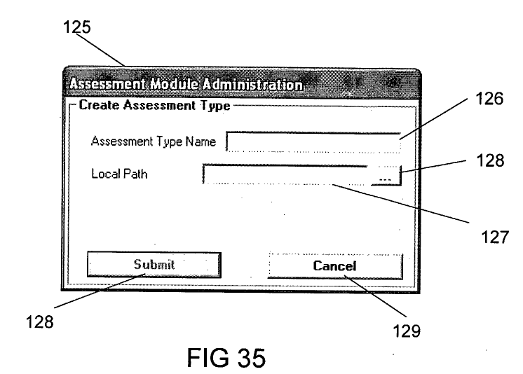

FIG. 35 is a schematic illustration of a dialog used to create a new assessment type in the process of FIG. 34;

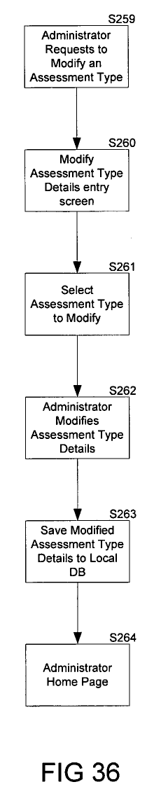

FIG. 36 is a flow chart illustrating a process used by the administrator to modify an assessment type;

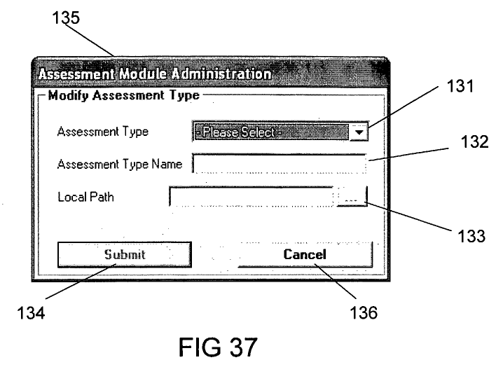

FIG. 37 is a schematic illustration of a dialog used to modify an assessment type in the process of FIG. 36;

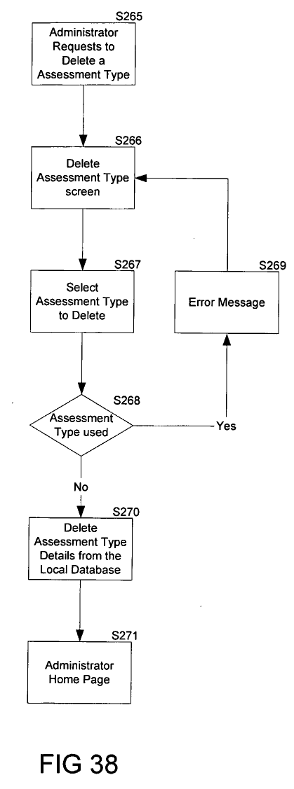

FIG. 38 is a flow chart illustrating a process used by the administrator to delete an assessment type;

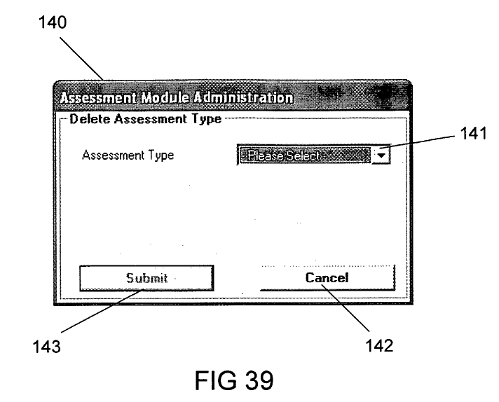

FIG. 39 is a schematic illustration of a dialog used to delete an assessment type in the process of FIG. 38;

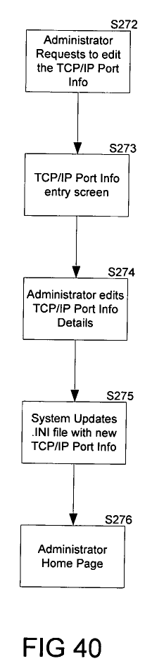

FIG. 40 is a flow chart illustrating a process used by the administrator to modify communications data; and

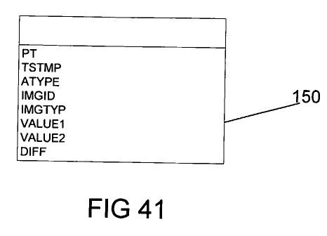

FIG. 41 is an illustration of a table of an Oracle clinical database used in embodiments of the present invention.

Referring first to FIG. 1, there is illustrated a network of computers 1 comprising tablet PCs 2, 3, 4 connected to switches 5, 6. The network also comprises a router 7. A controller PC 8 is connected to the switch 5, and to the router 7 and this controller PC is responsible for controlling image assessment operations. The controller PC 8 is connected to a projector 9 for projecting images onto a screen (not shown). The components of FIG. 1 are arranged such that images displayed on the screen by the projector 9 are visible by users of the tablet PCs 2, 3, 4. The connections between the tablet PCs 2,3,4, the switches 5, 6, and the router 7 are wired connections using category 5 network cabling. However, it will be appreciated that in some embodiments of the present invention, these components are connected together using wireless means, such as a Wireless Local Area Network (WLAN) operating in accordance with IEEE 802.11.

The router 7 has an interface to allow connection to the Internet 10. Via the Internet 10, the router 7 can communicate with a further remote router 11 which is connected a database server 12. Communication across the Internet 10 is carried out using a frame relay connection of a type which will be readily known to one skilled in the art. The database server 12 hosts an Oracle Clinical database, that is an Oracle database having various predefined tables which are particularly suitable for storing data related to clinical research.

It will be appreciated that the router 7 can communicate with the remote router 11 over any suitable network, which need not necessarily be the Internet 10. It will also be appreciated that in alternative embodiments of the present invention other secure communication mechanisms may be used to enable communication across the Internet 10, such as a Virtual Private Network (VPN). In some embodiments a non-secure communications channel may be used with encryption being used to ensure data security. The database server 12 need not host an Oracle Clinical database, but can instead host any suitable database, for example a ClinTrial database which is also particularly suitable for storing data relating to clinical research.

FIG. 2 illustrates the architecture of the controller PC 8 shown in FIG. 1 in further detail. It can be seen that the controller PC 8 comprises a CPU 13, random access memory (RAM) 14 comprising a program memory 14a and a data memory 14b, a non volatile storage device in the form of a hard disk 15, a Compact Disk ROM (CD-ROM) reader 16 and a network interface 17 for connection to the switch 5 and router 7 of FIG. 1. In some embodiments of the present invention the controller PC 8 is provided with two network interfaces, one for communication with the router 7 and one for communication with the switch 5. The Controller PC 8 also comprises an input/output (I/O) interface 18 to which various input and output devices are connected, including the projector 9. Suitable input devices such as a keyboard 19 and a mouse (not shown) are also connected to the I/O interface 18. A flat screen monitor 20 is also connected to the I/O interface 18 to allow information to be displayed to a user of the controller PC without being displayed on the screen which is visible to all users of the tablet PCs 2, 3,4. The CPU 13, memory 14, hard disk drive 15, CD-ROM reader 16, network interface 17 and I/O interface 18 are all connected together by means of a central communications bus 21.

The controller PC 8 operates using either the Microsoft Windows 2000 or Microsoft Windows XP operating system. The tablet PCs 2, 3, 4 operate using versions of these operating systems particularly designed for use on tablet PCs. Each of the tablet PCs 2, 3, 4 includes a touch screen which allows data to be input using a touch pen. The tablet PCs 2, 3, 4, are additionally provided with conventional keyboards but keyboards are not used in the embodiments of the invention described herein.

The components illustrated in FIGS. 1 and 2 together allow images to be displayed to a plurality of assessors (each using one of the tablet PCs) via the projector 9. A coordinator controls an image assessment session using the controller PC 8. The assessors review displayed images and use the tablet PCs 2, 3, 4 to enter assessment data indicative of image assessment which is transmitted to the controller PC 8. The controller PC 8 then forwards received assessment data to the database server 12 via the Internet 10.

An overview of the operation of the system of FIGS. 1 and 2 is now presented with reference to the flow chart of FIG. 3. At step S1, a coordinator logs on to the controller PC 8. The controller PC 8 provides a user interface which the coordinator uses to specify details of images which are to displayed to assessors using the projector 9, and data which is to collected relating to the displayed images.

At step S1a a database for storage of the data is selected. At step S2, an assessment method is selected and this selection indicates the type of assessment data that is to be collected relating to the displayed images. At step S3, the coordinator specifies a number of assessors from whom data is to be collected. This will correspond to a number of users each logging in to one of the tablet PCs 2, 3, 4. At step S4, images for display are loaded onto the hard disk 15 of the controller PC 8 from a CD ROM inserted into the CD ROM reader 16. At step S5, the controller PC 8 transmits a start message to each of the tablet PCs 2, 3, 4 via the switches 5, 6 and associated network cabling. At step S6, assessors logon using the tablet PCs 2, 3, 4 and this logon data is passed to the controller PC 8. When all necessary users have logged on, and other initialisation processing has been carried out (as described in further detail below), a first image is read from the data memory 14b and displayed to the assessors via the projector 9 (step S7).

At step S8, assessment data from each of the assessors is received at the controller PC 8 from the tablet PCs 2, 3, 4. Having received data from each of the tablet PCs 2, 3, 4, at the controller PC 8, the received data is uploaded to the database server 12 at step S9. Steps S7, S8 and S9 are repeated for each image for which data is to be collected. Embodiments of the present invention provide functionality to ensure that each assessor provides information for each image, and this functionality is described in further detail below.

FIG. 4 schematically illustrates a structure for software used to implement the present invention. The software comprises controller software 22 which is executed on the controller PC 8, and assessor software 23 which is executed on each of the tablet PCs 2, 3, 4. The controller software 22 comprises a TCP/IP module 24 which implements the commonly used transmission control protocol (TCP) and Internet Protocol (IP) communications protocols to allow communication between the controller PC 8 and other devices connected to the network illustrated in FIG. 1. The controller software 22 further comprises a coordinator module 25 which provides software to allow a coordinator to use the controller PC 8 to control the display of images and collection of assessment data. An administrator module 26 is provided to allow a user having suitable permission to make various changes to the configuration of the system, such as setting up of new users, controlling details relating to the data to be collected during an assessment session, and controlling communications settings. A security module 27 is provided to control all aspects of security including user logon, and monitoring of failed logon attempts for audit and security purposes.

An Oracle clinical connection module 28 is provided to allow data to be transferred from the controller PC 8 via the router 7 and remote router 11 to the Oracle clinical database stored on the database server 12. Finally, the controller software 22 comprises a local database 29 storing data pertinent to operation of the system as is described in further detail below.

The structure of the assessor software 23 is now described. The assessor software comprises a first group of modules 30 which provide general assessor functionality, a second group of modules 31 which provide functionality appropriate to the collection of a first type of assessment data, and third group of modules 32 which allow collection of a different type of assessment data. The first group of modules 30 comprises a security module 33 providing security functionality such as that described above with reference to the security module 27, but in the context of the tablet PCs 2, 3, 4. A TCP/IP module 34 provides functionality to allow the tablet PCs 2, 3, 4 to communicate with other components connected to the network illustrated in FIG. 1 using the commonly used TCP/IP protocols. An assessor module 35 provides general functionality for assessors using the tablet PCs 2, 3, 4.

The second group of modules 31 comprises a TCP/IP module 36 containing functionality specific to collection of assessment data using the second group of modules 31, and an Assessment Type I module providing functionality specific to collection of a first type of assessment data. The third group of modules 32 again comprises a TCP/IP module 38, and an Assessment Type II module 39 providing functionality specific to collection of a second type of assessment data.

Each of the software components illustrated in FIG. 4 is described in further detail with reference to subsequent figures.

FIGS. 5 to 7 illustrate tables stored in the local database 29. This database is implemented using the Microsoft SQL Server Desktop Engine (MSDE) and is stored on the hard disk drive 15 of the controller PC 8 (FIG. 2).

Referring to FIG. 5, there is illustrated a TEMP_DATA table which is used to temporarily store data relating to displayed images received form the tablet PCs 2, 3, 4 before such data is transmitted by the controller PC 8 to the database server 12. It can be seen that the TEMP_DATA table includes a Data_Timestamp field which stores a date and time which the assessment data was captured, an Assessor_Name and an Assesser_Username field which are used to store details of the assessor which provided data represented by a particular record of the TEMP_DATA table, and Assessment_Type, Image_Number, Image_Type, Value_{—}1 and Difference fields which are used to hold specific assessment data as is described further below.

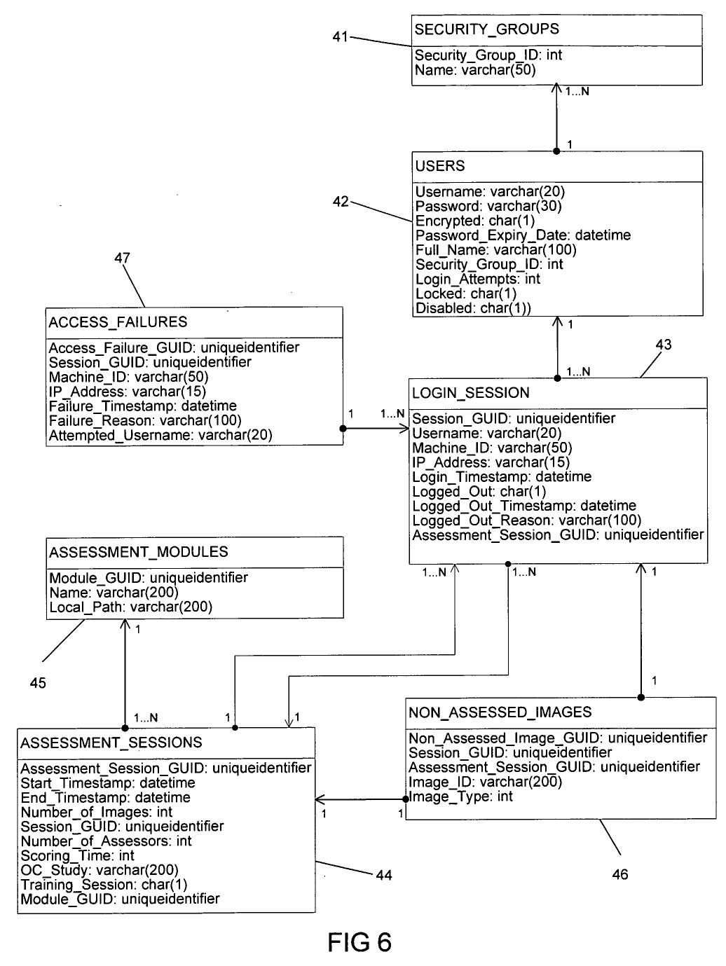

FIG. 6 illustrates tables used during an assessment session together with relationships between these tables. In the diagram of FIG. 6, cardinalities of relationships between the tables are illustrated on arrows denoting these relationships.

In order to control user access of the system, a SECURITY_GROUPS table 41 defines a plurality security groups each having an identifier stored in a Security_Group_ID field and an associated name stored in a Name field. Each of these security groups has associated with them different access permissions.

A USERS table 42 is used to store details of users who are authorised to use the system. The USERS table comprises a Username field storing a textual username for each user, a Password field storing a password, an Encrypted field indicating whether the password is stored in encrypted form, a date and time value indicating the password's expiry date in a Password_Expiry_Date field, a Full_Name field storing a full name for the user and a Security_Group_ID field identifying one of the records in the SECURITY_GROUPS table 41. The USERS table 42 further contains a Login_Attempts field storing the number of login attempts that a particular user has made, a Locked field indicating whether a user is locked out of the system, and a Disabled field. The Disabled field allows particular user records to be disabled by a administrator if that particular user is not to logon for any reason.

A LOGIN_SESSION table 43 contains data relating to a particular users logon session. A Session_GUID field stores a unique identifier for that session. A Username field identifies a particular user's record in the USERS table 42. A Machine_ID field and an IP_Address field provide details identifying one of the tablet PCs 2, 3, 4 to which the user is logging in. A Login_Timestamp field stores data indicating when a user logged on. A Logged_Out field indicated whether or not a user has yet logged out and a Logged_Out_Timestamp field indicates a date and time at which the user logged out. A Logged_Out_Reason field allows a reason for the log out to be specified. A login session as represented by a record of the LOGIN_SESSION table 43 represents a particular user's logon. In contrast, an assessment session as indicated by record in the ASSESSMENT_SESSIONS table 44 stores details relating to a complete assessment session comprising a plurality of records in the LOGIN_SESSION table 43. An Assessment_Session_GUID field of the LOGIN_SESSION table 43 uniquely identifies a particular assessment session of the table 44 to which the login pertains.

The ASSESSMENT_SESSIONS table 44 comprises a unique identifier stored in an Assessment_Session_GUID field. A Start_Timestamp field stores a data and time at which a session begins, and an End_Timestamp field stores a date and time at which a session ends. A Number_of_Images field indicates a number of images which are to be displayed and assessed during the assessment session. The Session_GUID field identifies one or more records of the LOGIN_SESSION table 43 indicating the user logins which are responsible for providing assessment data for a particular assessment session. A Number_of_Assessors field indicates the number of assessors contributing data to that particular assessment session. A Scoring_Time field indicates a length of time for which images are to be displayed to the assessor. An OC_Study field identifies a group of records (referred to as a study) in the Oracle Clinical database stored on the database server 12. This data is used to ensure that the controller PC 8 passes received assessment data to the correct part of the Oracle clinical database stored on the database server 12. A Training_Session field indicates whether or not the session is designated as a training session, the significance of which is described in further detail below.

It has been described above that the data to be collected about an image can be of one of a plurality of different types. The type of data to be collected is identified by an assessment module, and a Module_GUID field identifies a record in the ASSESSMENT_MODULES table 45 which provides details of the data to be collected. The ASSESSMENT_MODULES table 45 comprises a Module_GUID field providing a unique identifier for the module, a Name field providing a name for that module and Local_Path field indicating where code relating to that module can be found on the controller PC 8. By storing computer program code needed to capture assessment data on the controller PC 8, the appropriate assessment module (corresponding to one of the modules 31, 32 of FIG. 4) can be downloaded to one of the tablet PCs 2, 3, 4 as and when required. In this way, additional assessment types can be created and appropriate program code can be downloaded when required.

A NON_ASSESSED_IMAGES table 46 is used to allow details of missing data to be captured. It has been explained above that embodiments of the invention can allow mechanisms to be put in place to ensure that data is collected from each assessor for each displayed image. And the NON_ASSESSED_IMAGES table is used to provide this functionality. This table comprises a Non_Assessed_Image_GUID field storing a unique identifier, a Session_GUID field identifying a login session which failed to provide assessment data, an Assessment_Session_GUID field which identifies a record in the ASSESSMENT SESSIONS table 44 representing an assessment session in which the image was displayed, and Image_ID an Image_Type fields which provide details of the image for which data is missing. Use of this table is described in further detail below.

FIG. 6 also illustrates an ACCESS_FAILURES table 47 which stores data of each failed login to the system. This allows security within the system to be monitored. The table comprises an Access_Failure_GUID field which stores a unique identifier for each login failure. The table further comprises of a Session_GUID field identifying a login session, and Machine_ID and IP_Address fields identifying a tablet PC from which the failed login was carried out. A Failure_Timestamp indicates a date and time at which the failed login was attempted, and a Failure_Reason field indicates the reason for failure. An Attempted_Username field indicates the username which was input during the failed login process.

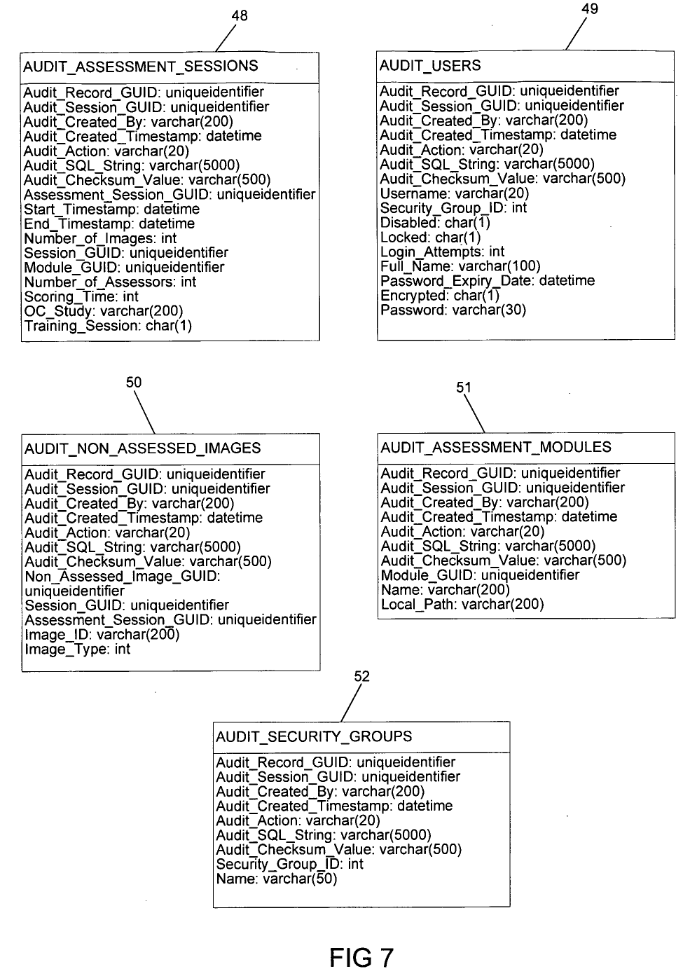

FIG. 7 illustrates five tables which together allow various audit functions to be carried out on the database, to ensure data integrity. These tables are an AUDIT_ASSESSMENT_SESSIONS table 48, an AUDIT_USERS table 49, AUDIT_NON_ASSESSED_IMAGES table 50, an AUDIT_ASSESSMENT_MODULES table 51 and an AUDIT_SECURITY_GROUPS table 52. Use of the tables of FIG. 7 is described in further detail below.

The tables illustrated in FIG. 7 are collectively used to store an audit trail of actions (e.g. update, modify, and delete actions) carried out on records in the equivalently named tables in FIG. 6. This audit trail is required to ensure that the system satisfies the requirements set out in 21 CFR Pt 11 issued by the Food and Drug Administration (FDA) of the United States of America as set out above and discussed in further detail below.

The tables illustrated in FIG. 7 are populated using database triggers which perform actions to a given database table whilst also recording said action in an audit table. This allows tracking of database changes performed within the software and those performed outside of the software.

The AUDIT_ASSESSMENT_SESSIONS table 48 is populated by the triggers firing against the ASSESSMENT SESSIONS table. These triggers record insert, update and delete operations relating to records of the ASSESSMENT_SESSIONS table 44. From the description set out above, it will be appreciated that records are stored to the ASSESSMENT_SESSIONS table 44 during the creation, running and completion of assessment sessions using the software.

The AUDIT_USERS table 49 is populated by triggers firing against the USERS table. These triggers record insert, update and delete operations relating to records of the USERS table. Records are stored in the USERS table 42 during the creation, modification and de-activation of users. The triggers of the AUDIT_USERS table 49 also record events such as password changes.

The AUDIT_NON_ASSESSED_IMAGES table 50 is populated by triggers firing against the NON_ASSESSED_IMAGES table 46. These triggers record insert, update and delete operations relating to the NON_ASSESSED_IMAGES table 46, Records are stored in the NON_ASSESSED_IMAGES table 56 when a user/users do not record an assessment of an image displayed and such records are manipulated by the software as it progresses through the scoring session, as described in further detail below.

The AUDIT_SECURITY_GROUPS table 52 is populated by triggers firing against the SECURITY_GROUPS table 41. These triggers record insert, update and delete operations relating to the SECURITY_GROUP table 41. Records are not inserted, updated or deleted in the SECURITY_GROUPS table 41 by the software but creation, modification and deletions of records of the SECURITY_GROUPS table 41 are performed directly to the database a audited in the AUDIT_SECURITY_GROUPS table 52.

It should be noted that for each entry recorded into one of the audit tables of FIG. 7 the SQL statement executed against the parent table is also stored. This therefore records the exact action performed against the parent table into a respective one of the audit tables.

Operation of the system to allow display of images and collection of assessment data is now described in further detail. Referring first to FIG. 8 there is illustrated a flowchart depicting options provided to a user logging in to the controller PC 8 as a coordinator, as provided by the coordinator module 25 of the controller software 22 (FIG. 4). At step S10 a user is presented with a home page which provides three options. At step S11 a user can select to change their password, at step S12 a user can select to logout from the system, and at step S13 a user can select to begin an assessment session. If a user selects to begin an assessment session at step S13, processing then passes to step S15 of FIG. 9 as indicated by step S14 of FIG. 8.

Referring now to FIG. 9, at step S16 a check is made to determine whether or not there exists a currently active assessment session. If there is no currently active assessment session processing passes directly to FIG. 10 at step S17. If however the check of step S16 determines that there is an active assessment session, processing passes to step S18 where a dialog is presented to the user providing options either to continue with the currently active assessment session or to cancel that currently active session. If the user chooses to cancel the currently active assessment session, processing passes to step S19 where images which were to have been displayed in the currently active assessment session are deleted from the hard disk 15 of the controller PC 8. Additionally, appropriate updates are made to the appropriate record of the ASSESSMENT_SESSIONS table 44 which represents the now cancelled assessment session. Appropriate amendments are also made to each record of the LOGIN_SESSION table 43 which relates to the now cancelled assessment session (step S20). Having deleted images from the cancelled assessment session and made appropriate amendments to the database tables, processing then passes to step S16 where the check for an active assessment session will return false and processing can then continue at step S17.

If, on being displayed with the dialog at step S18, a user chooses to continue with the currently active assessment session, the controller PC produces a random list of unscored images from the currently active assessment session. This is created by determining which images have not yet been displayed to a user, and can be deduced by comparing images stored on the controller PC 8 in appropriate folders (described below) with images for which data is stored in the Oracle Clinical database, or for which a record exists in NON_ASSESSED_IMAGES table 46 (step S21). Processing then passes to step S22, which diverts processing to step S35 of FIG. 10, as described below.

Referring now to FIG. 10, the processing undertaken to begin a new assessment session is described. At step S23, all records in the TEMP_DATA table 40 (FIG. 5) are deleted. The TEMP_DATA table 40 is used to store data on a temporary basis between receipt of such data at the controller PC 8 from the tablet PCs 2, 3, 4 and such data being transmitted to the database server 12. Given that a new assessment session is being created any data stored in the TEMP_DATA table 40 is no longer relevant and is accordingly deleted. Having deleted records of the TEMP_DATA table at step S23, a session set up dialog 53 (FIG. 11) is displayed to the user at step S24. At step S25, the user uses a drop down list 54 provided by the dialog 53 to select a study within the Oracle Clinical database stored on the database server 12 with which collected assessment data is to be associated. At step S26 a drop down list 55 is used to select a type of assessment data which is to be collected. The drop down list 55 is populated by reading the Name field of records of the ASSESSMENT_MODULES table 45. Having chosen a study at step S25, and an assessment type at step S26, a user then uses an image load button 56 to load images from a first CD ROM onto the controller PC 8 (step S27). When the image load button 56 is pressed, processing is carried out to determine whether or not there is a CD ROM in the CD ROM reader 16, and if no such CD ROM exists an appropriate error message is displayed to the user. When an appropriate CD ROM is present in the CD ROM reader 16, images are loaded from the CD ROM onto the hard disk 15 of the controller PC 8 (step S27a). These images are stored within a “batch 1” folder on the hard disk 15 of the controller PC 8. Having loaded images from a CD ROM to the “batch 1” folder, at step S28 a user inserts a different CD ROM into the CD ROM reader 16 and selects a second image load button 57 provided by the dialog 53 to cause images from the second CD ROM to be copied to the hard disk 15 of the control PC 8. These images are stored within a “batch 2” folder on the hard disk 15.

It should be noted that in the described embodiment of the present invention, it is required that the first and second CD ROMs inserted into the CD ROM reader 16 are different CD ROMs. This is facilitated by storing the volume label of the first CD ROM when data is read from that CD ROM, and comparing this stored volume label with that of the second CD ROM. This comparison is carried out at step S29, and if it is determined that the volume labels do match (indicating that the same CD ROM has been placed in the CD ROM reader twice) an appropriate error message is displayed to the user at step S30, and processing returns to step S28 where the user can insert a further CD ROM into the CD ROM reader 16 and select the second image load button 57 to cause images to be loaded in the “batch 2” folder of the controller PC 8. It should be noted that no images are actually copied from the CD ROM to the “batch 2” folder until the check of step S29 indicates that the first and second CD ROMS are different. Images are loaded from the CD ROM into the “batch 2” folder at step S31.

Having loaded appropriate images into the “batch 1” and “batch 2” folders of the controller PC 8 processing then passes to step S32 where a randomly ordered list of images stored in both the “batch 1” and the “batch 2” folders of the controller PC 8 is created. It should be noted that this randomly ordered list may contain some images more than once.

The division of images into two distinct folders allows two distinct subpopulations of images to be created. When data relating to an image is captured, it is stored together with data identifying the image to which it relates. The identifier identifying each image can be generated so as to indicate whether the image is taken from the “batch 1” folder or the “batch 2” folder, therefore allowing captured data relating to the two subpopulations of data to be distinguished within the stored data. For example, images stored in the “batch 1” folder may be those for which scoring data is to be collected and stored, while images stored in the “batch 2” folder may be those which are to be used for consistency checking. For example, the “batch 2” folder may contain a number of images which are to be repeated so as to ensure scorer consistency. The images stored in the “batch 2” folder may also be common to a number of assessment sessions so as to allow inter-session consistency to be monitored.

At step S33, the user uses a slider bar 58 to input into the dialog 53 a number of assessors who are to contribute assessment data for this assessment session. At step S34, a user uses a slider bar 59 to input a time value indicating a number of seconds with which assessors will be provided to provide assessment data (as described below). The processing described above with reference to steps S23 to S34 provides all data required to configure an assessment session. It should be noted that the dialog 53 is configured to ensure that the steps described above are carried out in the order in which they are described by only enabling particular elements of the dialog 53 after certain elements have been used to provide particular information. For example it can be seen that in FIG. 11, the drop down list 54 is available for use but the drop down list 55, the image load buttons 56, 57 and the slider bars 58, 59 are greyed to prevent use.

Having configured an assessment session in the manner described above, processing then passes to step S35 where a user uses a button 60 to trigger acceptance of client connections. Each client connection will be a connection from an assessor using one of the tablet PCs 2, 3, 4 to provide assessment data. Each client connection will be associated with a record in the LOGIN_SESSION table 43 of the local database. The controller PC then waits until the requisite number of connections has been received. At step S36 a check is carried out to determine whether the coordinator has chosen to cancel the assessment session. Assuming that the session has not been cancelled processing passes to step S37 where a check is carried out to determine whether the specified number of connections have been made. Assuming that the specified number of connections has not been made steps S36 and S37 are repeated until such time as either the required number of connections has been made or the user chooses to cancel the session. If the user chooses to cancel the session at step S36, images are deleted from both the “batch 1” and “batch 2” folders on the hard disk 15 of the controller PC 8 at step S38, and records of the LOGIN_SESSION table 43 relating to logins for the particular assessment session are appropriately updated at step S39. Having done this, at step S40 processing returns to FIG. 8 where the coordinator is again presented with a coordinator home page.

Assuming that the session is not cancelled at step S36 the loop of step S36 and S37 exits when the specified number of connections has been received. When the specified number of connections is received processing passes to step S41 at which a user is presented with further dialog which is used to commence an assessment session. This dialog can also be used to choose to cancel the session by returning to the coordinator home page by selecting an appropriate button. Use of this button is detected at step S42, and if the button is selected processing passes to step S38 where the processing described above is carried out. Assuming that a user does not choose to return to the home page at step S42 a user can choose to designate that the session is a “training session”. That is a session which is to be used to train assessors and for which data is not to be written to the Oracle clinical database. This is done at S43 by entering a “tick” in an appropriate tick box of the further dialog. If a tick is placed in the tick box, processing passes to step S44 where the session is designated as a training session, the significance of which is described in further detail below. Either after designation of a session as a training session at step S44, or after processing of step 43 where the session is not a training session processing then passes to step 46 of FIG. 12, at step S45.

Referring now to FIG. 10A, an alternative process for setting up an assessment session is illustrated. Portions of the flowchart of FIG. 10A shown in broken lines are identical to corresponding portions of the flowchart of FIG. 10. However, it can be seen that step S32 of FIG. 10 has been replaced by steps S32a to S32i in FIG. 10A.

Referring now to FIG. 10A it can be seen that having loaded images from CD2 at step S31, a check is carried out at step S32a to determine whether the combination of CD1 and CD2 have been used in a previous assessment session. It will be appreciated that this check will involve comparing the IDs of the two CDs, with data stored in an appropriate database. If it is determined that this combination of CDs has not been used previously, processing continues at step S32b where the images are randomised in a manner akin to that of step S32 of FIG. 10. Having randomised the images at step S32b, the randomisation generated is stored at step S32c in an appropriate database. Data stored at step S32c includes identifiers of the first and second CDs so as to allow this randomisation data to be retrieved should that combination of CDs be used in future. Additionally, the data stored at step S32c includes the date and time of the assessment session so that a stored randomisation can be selected on the basis of date and time for future assessment sessions. Thus, having completed the processing of step S32c it can be seen that the images have been randomised as necessary, and appropriate data has been stored such that processing can continue at Step S33.

If the check of step of S32a determines that the combination of CDs now used has been used previously, processing passes to step S32d where a prompt is presented to the user. This prompt requires the user to either select a new randomisation or an existing randomisation, and the user input is processed at step S32e. It will be appreciated that there are benefits in allowing a user to select as between a previous randomisation and a new randomisation. Particularly, if an assessment session is to be repeated and it is desired to perform the repeated session under identical conditions to the initial session, the same randomisation would preferably be used. However if a different session is to be run a new randomisation would in that case be preferred. In the case that the input received at step S32e indicates that a new randomisation is to be generated, processing passes from step S32e to step S32b where a randomisation is generated and processing there proceeds as discussed above. If however the input received at step S32e indicates that an existing randomisation should be used, processing passes to step S32f. At step S32f, a check is carried out to determine how many randomisations are stored in the database for the combination of CDs now being used. It will be appreciated that this check will involve querying the database using CD IDs to identify data stored at step S32c of previous assessment sessions. If it is determined that there is more than one randomisation associated with this particular combination of CDs, processing passes from step S32f to step S32g where a user is prompted to select one of the previously used randomisations. This prompt preferably provides to the user a list of previously used randomisations on the basis of the date and time at which those randomisations were used. From step S32g, processing continues at step S32h where a selection of one of the displayed randomisations is received. The selected randomisation is then read at step S32i from where processing continues at step S33. If the check of step S32f determines that there is only one randomisation associated with a particular combination of CDs it can be seen that processing passes directly from step S32f to step S32i.

It will be appreciated that variant of the process for setting up an assessment session described with reference to FIG. 10A provides additional flexibility in allowing an assessment session to be rerun under identical conditions, that is rerun with an identical randomisation.

In embodiments of the invention in which an assessment session is set up using the process illustrated in FIG. 10A, some modification is needed to the process of FIG. 9. Specifically, referring to FIG. 9, if at step S16 an active session is identified and continued at step S18, instead of producing a randomised set of images at step S21, undisplayed images of a previously randomised set of images are read in accordance with the previous randomisation. This will ensure that if an assessment session which is to be re-run under identical conditions is interrupted, it can be continued using the previously generated randomisation.

The processing described above with reference to FIGS. 9, 10 and 10A has been concerned with setting up of an assessment session and connection of the tablet PCs 2, 3, 4 to the controller PC 8. With reference to FIGS. 12 and 13 the collection of assessment data is now described.

Referring first to FIG. 12, at step S47 a message is sent from the controller PC8 to each of the tablet PCs 2, 3, 4. This message indicates that an assessment session is about to begin and prompts assessors to click a “Join assessment session” button to indicate that they are ready to start providing assessment data. A loop is then established at step S48 awaiting all users clicking the “start session” button. When all users have selected this button processing then passes to step S49 where a check is carried out to determine whether or not a record exists for the present assessment session in the ASSESSMENT_SESSIONS table 44 of the local database. If it is determined that no session exists a new record is created in the ASSESSMENT_SESSIONS table 44 at step S50. If an appropriate record does exist, this record is appropriately updated at step S51. The data stored in the ASSESSMENT_SESSIONS table 44 has been described above, and it will be appreciated that the data required by a record in this table will be known from the data which has been input by the coordinator into the dialog 53 described above. It can be seen that the ASSESSMENT_SESSIONS table 44 includes a Training_Session field which is set to indicate whether or not the current session is a Training Session. Each record in the ASSESSMENT_SESSIONS table 44 additionally refers to records of the LOGIN_SESSIONS table 43 identifying assessor logins which are providing assessment data. Having created or updated an appropriate record in the ASSESSMENT_SESSIONS table 44 at step S50 or step 51 processing can now be carried out to collect assessment data.

At step S52 a first image from the previously created randomised list (step S32, FIG. 10) is selected for display. At step S53 the selected image is displayed to the user by projecting the image onto a screen using the projector 9 (FIG. 2). The controller PC 8 then sends a message to each of the assessors to initiate image assessment (step S54). Assessment data is then required from each of the assessors using one of the tablet PCs 2, 3, 4. At step S55 a check is carried out to determine whether image assessment data from each of the assessors has been received. If some assessors have not yet provided assessment data, processing passes to step S56 where a timeout check is carried. That is, a check is made to determine whether or not the image has yet been displayed for the time specified by the coordinator at step S34. Assuming that the timeout limit has not yet been reached, processing passes to step S57 where the controller PC is able to receive scores provided from the tablet PCs 2, 3, 4. Having received assessment data at step S57, a check is carried out at step S58 to determine whether or not the present session is a training session (which is discernable from the appropriate record of the ASSESSMENT_SESSIONS table 44). If the present session is a training session the data need not be captured and accordingly processing returns to step S55. Otherwise, it is necessary to store the received scored data in the TEMP_DATA table 40 (FIG. 5) so that the data can, in due course, be forwarded to the database server 12. The data stored in the TEMP_DATA 40 is described in further detail below. Having stored data in this table processing then returns to step 55.

The loop described above will exit either when assessment data is received from all assessors (step S55) or when the timeout limit is reached (step S56). If the timeout limit is reached, this is an indication that at least one of the assessors has failed to provide assessment data. Accordingly, a new record is created in the NON_ASSESSED_IMAGES table 46 of the local database stored on the controller PC 8. The Non_Assessed_Image_GUID field provides a unique identifier for the missing assessment data. The record also comprises a Session_GUID field which indicates the login session responsible for the missing data, and an Assessment_Session_GUID field identifying the current assessment session together with details of the image for which data has not been provided. When the record has been created in the NON_ASSESSED_IMAGES table 46, processing passes to step S61. It should be noted that if the loop of steps S55 to S59 exit when all responses have been received, it can be deduced that there is no missing data and accordingly processing passes directly from step S55 to step S61.

At S61 the projector 9 displays no image such that the screen is “blanked” to provide a delay between images. At step S61a a check is carried out to determine whether or not the session is marked as a training session. If the assessment session is not marked as a Training Session, data is copied from the TEMP_DATA table 40 to the Oracle Clinical database stored on the database server 12 at step S62. Having done this, records of the TEMP_DATA table can be deleted at step S63, and processing continues at step S64. If the check of step S61a determines that the current assessment session is a training session, processing passes directly to step S64. At step S64 a check is carried out to determine whether the present image is the last image to be displayed. Assuming that the image which has been displayed is not the last image, processing passes to step S64a where the next image for display is selected and processing then passes to step S53 and continues as described above. When all images have been displayed (that is if the condition of step S64 is satisfied), a check is carried out at step S65 to determine whether or not there are any unscored images (that is whether or not there are any records in the NON_ASSESSED_IMAGES table which relate to the present session.) If unscored images exist, processing passes to step S71 of FIG. 13 at step S66, which is described in further detail below.

If no unscored images are located at step S65, processing passes to step S67 where a message indicating successful completion of the assessment session is displayed to the user. The assessment session record in the ASSESSMENT_SESSIONS table 44 is marked as completed at step S68, and images are deleted from the “batch 1” and the “batch 2” folders of the controller PC 8 at step S69. At step S70 processing returns to step S10 of FIG. 8 where the coordinator is again provided with a coordinator home page described above.

It was described above that if assessment data for some images has not been collected from all assessors, processing is carried out to present these images to the assessors again, so as to obtain appropriate assessment data. This processing is now described with reference to FIG. 13. It should be noted that processing passes to step S71 of FIG. 13 from step S66 of FIG. 12. At step S72, a message is displayed to the coordinator on the flat screen monitor 20 indicating that there are unscored images. At step S73 a report of unscored images is generated and presented to the coordinator again using the monitor 20. At step S74 the coordinator is prompted to re-run display of images for which data has not been received from all assessors. On pressing a button in response to this prompt, at step S75 a message is sent to each assessor which failed to provide assessment data for all images. At step S76 a first image (for which assessment data is missing) is selected for display, and this image is displayed at step S77 using the projector 9. At step S78 the coordinator initiates data collection as described above. At step S79 a check is carried out to determine whether assessment data has been received from all assessors. It should be noted that here data for a particular image is collected only for assessors having their Session_GUID stored in a record of the NON_ASSESSED_IMAGES table 46 which has an Image_ID relating to that image. If data has not yet been received from all appropriate assessors, processing passes to step S80 where a timeout check is carried out. Assuming that there is no timeout, a score is received at step S81 and stored in the TEMP_DATA table at step S81a. If the assessment session is not a training session a respective record of the NON_ASSESSED_IMAGES table is then deleted for the appropriate image user combination. The received data is then forwarded to the Oracle database on the database server 12 at step S82.

The loop of steps S79 to S82 continues until either data is received from each appropriate assessor from whom data is required (step S79) or the timeout limit is reached (step S80). If the loop exits through the timeout of step S80, it can be deduced that at least some of the appropriate assessors have failed to provide assessment data. Details of such missing data are recorded in the NON_ASSESSED_IMAGES table at step S83, and processing then passes to step S84. It should be noted that if the loop of steps S79 to S82 exits at step S79, it can be deduced that there is no missing data, and processing therefore passes directly to step S84, where a wait command is executed to cause a delay.

At step S85, a check is carried out to determine whether further images are to be displayed. If further images are to be displayed, a next image for display is selected at step S86, and processing then continues at step S77 as described above. If however the previously displayed image is the last image to be displayed, at step S87 a check is carried out to determine whether there is still any missing data, by querying the NON_ASSESSED_IMAGES table 46. If there is no missing data, processing passes to step S88, and then to step S67 of FIG. 12. If however there is missing data, processing returns to step S72.

It should be noted that for each image for which assessment data is missing, a different set of assessors may be required to provide assessment data. This can be deduced from the NON_ASSESSED_IMAGES table 46, by discovering which users login sessions are referred to in the Session_GUID field of records having a particular Image_ID. Therefore, the check of step S79 may well differ for different images.

It should be noted that at any time during the processing described above the coordinator may choose to cancel the assessment session. This is shown in FIG. 14. It can be seen that a loop established by step S89 exits only if a “cancel” button is pressed, whereupon the coordinator is again presented with the homepage denoted by step S10 of FIG. 10. For example, the dialog 53 (FIG. 11) includes a “Return to Homepage” button 61 to provide this functionality.

The preceding description has been concerned with use of the controller PC 8 to set up an assessment session and collect assessment data. It has been briefly mentioned that different types of assessment data can be collected. The way in which this data is collected is now described, with reference to the graphical user interface provided to assessors using the tablet PCs 2, 3, 4, and with reference to the data which is input via that interface.

FIG. 15 is a flowchart depicting operation of a GUI provided to assessors using the tablet PCs 2, 3, 4 by the assessor module 33 of the assessor software 23 (FIG. 4). At step S91, a user logs in by providing a user name and password (described in further detail below). An assessment module comprising program code appropriate for the current assessment session is then downloaded (step S91a) indicating what assessment data is to be collected, as described below. The user is then presented with a homepage 70 (FIG. 16) at step S92 providing a option to change a password (step S93) by using a button 71 or logout (step S94) by using a button 72. In normal use, the user will arrive at the homepage at step S92 and await a command to begin an assessment session (step S47, FIG. 12) from the controller PC 8. On receipt of a command to begin an assessment session a user confirms that they are ready to begin by selecting a button 73. It should be noted that the button 73 is activated only on receipt of an appropriate command from the controller PC 8.

In the described embodiments two assessment schemes are used, and these are now described. From the homepage 70 at step S92, if the assessment module downloaded at step S91a relates to type 1 assessment data processing passes to step S95, and then to step S99 of FIG. 17 at step S96 of FIG. 15. This functionality is provided by the Assessment Type I module 37 of the assessor software 23 (FIG. 4).

Referring to FIG. 17, at step S100 a check is carried out to determine whether or not the assessment session has ended. If the session has ended (e.g. by action of the coordinator using the controller PC 8), a message is displayed to the assessor at step S101, indicating that the session has ended and requiring a user to acknowledge that the session has ended. Having received this user acknowledgement (step S102), the user is logged out at step S103, and processing ends at step S104.

If the assessment session has not ended, processing passes from step S100 to step S105, where a loop is established until an initiation command is received from the controller PC 8 indicating that an image has been displayed using the projector 9. When an initiation command is received, processing passes to step S106 where a data input screen 80 as illustrated in FIG. 18 is displayed to the assessor an a display device of one of the tablet PCs 2, 3, 4. It can be seen from FIG. 18 that the data input screen comprises a scale 81 which is used to input assessment data. The scale 81 is used to capture a visual analogue score and represents values extending between a value of ‘0’ at one extreme of the scale and a value of ‘10’ at the other extreme. The image displayed to the assessors using the projector 9 will be an image of a scar, for example a human skin scar, and the scale is used to indicate the severity of the scar. A position indicating value of ‘0’ indicates that the scar is not perceivable by the assessor (i.e. the image is effectively one of unscarred skin) and a position indicating a value of ‘10’ indicates very severe scaring.

Data is input using the scale 81 by a user using a touchpen to locate a position on the scale 81 displayed on the display screen of one of the tablet PCs 2, 3, 4. Input is awaited at step S107, and at step S108 a check is made to determine whether a timeout limit has been reached, the time out limit having been communicated to the tablet PCs 2, 3, 4 by controller PC 8. Assuming that the timeout limit is not reached, processing returns to step S106, and steps S106, S107 and S108 are repeated until either input is received, or the timeout condition is satisfied.

When input is received, the position marked on the scale 81 is converted into a real number score (step S109). The interface is configured to measure input position on the scale 81 to an accuracy of 0.05 cm. The score is then transmitted to the controller PC 8 at step S110. At steps S111 and S112 the assessor interface waits until either a timeout condition is satisfied for receipt of data from all assessors, or all other assessors have provided assessment data. Processing then passes to step S113 where the data entry screen is removed from the display of the tablet PCs 2, 3, 4. It should be noted that if at step S108 the timeout condition is satisfied and input is not received, processing passes directly from step S108 to step S113. After removal of the data entry screen (step S113), a wait command is executed at step S114 and processing then returns to step S100.

The preceding description has been concerned with the display of a single image to a user, and collection of visual analogue data relating to that image. An alternative method for collecting assessment data is described with reference to FIGS. 19 to 21.

Referring back to FIG. 15, if the assessment module downloaded at step S91a relates to type II assessment data on selection of the displayed button 73 (FIG. 16) processing passes to step S97, and then at step S98 to step S116 of FIG. 19. This functionality is provided by the Assessment Type II module 39 of the assessor software 23.

Referring to FIG. 19, at step S117, a check is made to determine whether the assessment session has ended. If the assessment session has ended, processing passes to step S118 where a message is displayed to a user, then to step S119 where user input is received, and then to step S120 where the user is logged out, before processing terminates at step S121. If the session has not ended, processing passes from step S117 to step S122 where receipt of a command to provide assessment data is awaited. When a command to provide assessment data is received a data input screen 85 illustrated in FIG. 20, is displayed to the assessor at step S123.

It should be noted that in this assessment mode, a pair of images is displayed to assessors for assessment using the projector 9. A first image is referred to as an anterior image, and a second image is referred to as a posterior image. The data to be collected indicates whether the scarring indicated by each image of the pair of displayed images is considered to approximately the same, whether the anterior image is better, or the posterior image is better. This information is captured using three buttons presented using the data input screen 85. A first button 86 is labelled “Image ‘A’ Better”, a second button 87 is labelled “Image ‘B’ Better” and a third button 88 “Both the same”.

At step S124 a check is made to determine whether one of the buttons 86, 87, 88 has been selected. If input has not yet been received, processing passes to step S125 where a check is made to determine whether the allocated time for providing information has expired. If time has not expired, processing returns to step S123 and steps S123 and S124 are repeated until either data is received, or time expires. If time expires, the loop exits at step S125 and processing passes to step S133, which is described below. However, if the loop exits at step S124 when input is received, at step S126 the received input data is processed to determine which of the three buttons was selected by the assessor. If the button 88 has been selected indicating that the scarring between the pair of images was substantially the same, processing then passes to step S127 where this data is transmitted to the controller PC 8.

However, if the button 86 indicating that the scarring of image A is better is selected, or the button 87 indicating that the scarring of image B is better is selected, processing passes from step S126 to step S128 where a further data input screen 90 (FIG. 21), is displayed to the assessor. It can be seen that that the data input screen 90 asks the assessor to indicate whether the difference between the displayed images is slight or obvious. The assessor inputs the requested information by selecting one of two provided buttons, a first button 91 marked “Difference is Slight”, and a second button 92 marked “Difference is obvious”.

Referring back to FIG. 19, at step S129 user input in the form of selection of one of the buttons 91, 92 is awaited. If input has not been received, a timeout check is made at step S130, and steps S128, S129 and S130 are repeated until either input is received (step S129), or a timeout condition is satisfied (step S130). If the timeout condition is satisfied, processing passes directly to step S133, which is described below. However, if input is received at step S129, processing passes to step S127 where the input data (collected using the dialogs of FIGS. 20 and 21) is transmitted to the controller PC 8.

From step S127, processing passes to step S131 where a wait message is displayed to the assessor until such time as data has been received from each of the assessors, or such time that a timeout condition is satisfied. This is achieved by the loop of steps S131 and S132. When the wait message is no longer to be displayed, processing passes to step S133, where the data entry screen is removed from the display, a wait command is executed at step S134, and processing then returns to Step S117 where it continues as described above.

The description set out above has set out two different types of assessment data which can be captured using the described embodiments of the present invention. It has also been described that data received by the controller PC 8 is initially stored in the TEMP_DATA table 40 illustrated in FIG. 5. The relationship between fields of the TEMP_DATA table 40 and collected assessment data is now described. Use of the Data_Timestamp, Assessor_Name, and Assessor_Username has been described above. The Assessment_Type field is used to indicate the type of assessment data stored, i.e. differentiating between data for a single image, and comparative data for a pair of images. The Image_umber field identifies a particular image, and the Image_Type field indicates an image type (i.e. single image or pair of images) represented by an integer. The Value_{—}1 field and the Difference field together store a single item of assessment data. Where data is being collected for a single image (FIG. 17) the Value_{—}1 field stores a real number representing the data input by the user using the scale 81 (FIG. 18). In this case the Difference field is not used. However, where data is collected for a pair of images (FIG. 19), the Value_{—}1 field indicates one of three values—Same, Image A Better, or Image B better. Where the Value_{—}1 field indicates Same, the Difference field is not used. However, when the Value_{—}1 field indicates that one image is perceptibly better, the Difference field is used to indicate whether the difference is slight or obvious, based upon input made using the input screen of FIG. 21.

In embodiments of the invention in which particular randomisations of images may be reused, as illustrated in and described with reference to FIG. 10A above, the TEMP_DATA table 40 may additionally include a field identifying the randomisation scheme associated with the stored data. It will be appreciated that in such case this data will, in the same way as other data, be copied from the TEMP_DATA table to the Oracle clinical database. In this way, particular assessment information can be processed with reference to the randomisation scheme associated with its capture.

It has been mentioned above that the database stored on the controller PC 8 includes a USERS table, a LOGIN_SESSION table and a SECURITY_GROUPS table. These tables are all provided to control user access to the system using the security module 27 of the controller software 22 and the security module 33 of the assessor software 23 (FIG. 4), and their use is now described.

Referring first to FIG. 22, a log in process is described which is used by users logging in to one of the tablet PCs 2, 3, 4 or the controller PC 8. At step S135 either the controller software 22 or the assessor software 23 (FIG. 4) is launched. At step S136 a check is made to determine whether software is already running. If software is running an appropriate error message is displayed and the software exits at step S137. Assuming that the software is not already running, at step S138, a check is made to determine the type of hardware which is being used for the logon. If the controller PC 8 is being used, processing passes to step S139 where a login dialog is displayed to the user. However, if one of the tablet PCs 2, 3, 4 is being used, processing passes to step S140 where a check is made to ensure that the tablet PC can communicate with the controller PC 8. If the tablet PC is unable to establish a connection, an error message is displayed at step S141 indicating that a connection cannot be established, and processing terminates at step S142.

Assuming that the tablet PC is able to connect to the controller PC 8 at step S140, a check is made at step S143 to determine whether or not the number of assessors specified for the assessment session have connected to the controller PC. If the required number of assessors have connected, no further connections can be allowed, and accordingly a suitable error message is displayed at step S144 and processing again ends at step S142. Assuming that all assessors have not yet connected, processing passes from step S143 to step S139 where an appropriate login dialog is displayed. On being presented with the login dialog the user inputs a user name and password at step S145, and, if the details were input to one of the tablet PCs 2, 3, 4, the input details are transmitted to the controller PC 8. At step S146 a check is made to determine whether a valid user id has been entered. This involves checking that the input user id matches the Username field of a record of the USERS table 42 (FIG. 6). If the user id cannot be located, a record is created in the ACCESS_FAILURES table 47 (FIG. 6) to show this failed login at step S147, and an appropriate error message is displayed at step S148. Processing then returns to step S139.

Assuming that a valid username is input, processing passes from step S146 to step S149. Checks are then made to ensure that the type of hardware which is being used for the logon (i.e. controller PC or tablet PC) matches the security group to which the user has been allocated. For example, a coordinator or administrator can only logon using the controller PC 8, while an assessor can only log on using a tablet PC 2, 3, 4. A user's security group is determined by locating the user's record in the USERS table 42 and identifying the user's security group from the Security_Group_ID field of their record. At step S149, if the hardware being used is a tablet PC, a check is made to determine whether the user's security group is administrator or coordinator. If this is the case, the log in can not be permitted, and an appropriate error message is displayed at step S150 before the system closes at step S151. However, if the hardware is the controller PC 8, or if the user's security group is assessor, then processing passes from step S149 to step S152 where a check is made to determine whether an assessor is attempting to login using the controller PC 8. If this is the case, again the login cannot be allowed, and an appropriate error message is displayed at step S153 before the system closes at step S151. If step S152 determines that an assessor is not attempting to logon using the controller PC 8, processing passes from step S152 to step S154, and it is known that the hardware being used in appropriate to the user's security group.

At step S154 a check is made to determine whether the password associated with the input username is held in the USERS table 42 in encrypted form, by checking the Encrypted field of the user's record. If the password is held in the database in encrypted form, the input password is encrypted at step S155 before being checked against that stored in the database at step S156. If the Encrypted field of the user's record indicates that the password is not stored in encrypted form, processing passes directly from step S154 to step S156. If the input password does not match that stored in the USERS table 42, processing passes from step S156 to step S157 where the number of incorrect passwords is incremented by incrementing the LoginAttempts field of the user's record in the USERS table 42 and at step (S157a) a record is stored to the ACCESS_FAILURES table indicating this failure. In the described embodiment of the invention, a user may only input an incorrect password three times before their account is disabled. At step S158, a check is made to determine whether an incorrect password has been entered three times. If this is the case the user's account is disabled at step S159 (by setting the Disabled field of the user's record in the USERS table 42), and an error message is displayed at step S160. If an incorrect password has not been entered on three occasions processing passes from step S158 to step S145 where the user is again prompted to enter their username and password.

If the input password is found to be correct at step S156, the number of incorrect passwords entered stored in the LoginAttempts field of the USERS table is reset to zero. At step S161, the status of the user's account is checked by first checking the Disabled field of the user's record in the USERS table 42. If the user's record is disabled, the user is not permitted to use the system. Accordingly an audit record is created to store details of the login attempt at step S162 and a suitable error message is displayed at step S163.

If step S161 determines that the user is already logged in (which is the case if there is a record in the LOGIN_SESSION table 43 which refers to the user's record in the USERS table 42) the user is prompted to enter their username and password again at step S164 to confirm that they wish to terminate their previous login session and login again. If the details are correctly re-entered at step S164, the user is logged out of their previous login session at step S165, and processing passes to step S166. It should be noted that login details input at step S164 are processed in a similar way to that described with reference to relevant parts of FIG. 22, although this processing is not described in further detail here. If the status check of step S161 determines that the user's record is not disabled, and also determines that the user is not currently logged in, processing passes directly from step S161 to step S166.

If an assessment session is being re-started, only assessors who contributed to the original assessment session are allowed to log on to contribute assessment data. Therefore, at step S166 a check is made to determine whether or not the user is allowed to join the current assessment. If the user is not allowed to join the assessment session, an appropriate message is displayed at step S167, and processing then ends at step S168.

Assuming that the user is allowed to join the assessment session (or the user is an administrator or coordinator), processing passes from step S166 to step S169 where a check is made to determine whether the user's account has expired, by checking the Password_Expiry_Date field of the user's record in the USERS table 42. If the user's account has expired, an appropriate message is displayed at step S170. The user is then prompted to change their password at step S171, as described below with reference to FIG. 23. When the password has been changed, processing passes to step S172 where the user is logged on. This involves creating a new record in the LOGIN_SESSION table 43, storing the user's username, details of the machine used for the login, the date and time of the login, and details of an assessment session (if any) to which the login pertains.

If the user has logged in as an assessor (step S173), an assessment module (appropriate to the type of assessment data which is to be collected) is provided at step S174. Processing then passes to step S175 where the user's security group is determined, and an appropriate homepage is then provided at step S176. The provided assessment module will execute to allow one of the tablet PCs 2, 3, 4 to capture the required assessment data. The downloaded assessment module will correspond to one of the modules 31, 32 illustrated in FIG. 4, dependent upon the data to be collected. By downloading assessment modules as and when required it will be appreciated that additional assessment types can be created by creating a new record in the ASSESSMENT_MODULES table 45 (FIG. 6) and storing an appropriate assessment module on the controller PC 8 which is available for download when required. Thus, it will be appreciated that the described system can easily provide alternative assessment mechanisms, some of which are described in further detail below.

It has been described above, that both the coordinator homepage (FIG. 8) and the assessor homepage (FIGS. 15 and 16) provide options allowing users to change their password. Similarly, it has been described, that a change password procedure is carried out at step S171 of FIG. 22. The change password procedure is now described with reference to FIG. 23.

Referring to FIG. 23, at step S178 a user makes a password change request. This can be done either by selecting an appropriate button within a homepage (e.g. the assessor home page of FIGS. 15 and 16, or the coordinator homepage of FIG. 8) or during a logon process if the user's password has expired. At step S179 an appropriate dialog is displayed to the user as illustrated in FIG. 24. The displayed dialog provides three textboxes—a Current Password textbox 95, New Password textbox 96 and a Confirm New Password textbox 97. The dialog is also provided with a cancel button 98 and a submit button 99. If the user selects the cancel button, the homepage is again displayed to the user.

In normal operation, the user inputs their current password into the Current Password textbox 95 and their desired new password into both the New Password textbox 96 and the Confirm New Password textbox 97. The submit button 99 is then pressed. Processing then passes to step S180 where a check is made to determine whether or not the user's password is stored in the USERS table 42 of the database in encrypted form. This is indicated by the value of the Encrypted field of the user's record in the USERS table 42. If the password is stored in encrypted form, the password entered in the Current Password textbox 95 is encrypted at step S181, and processing then passes to step S182, where the entered current password is compared with that stored in the database. If the password is not held in the database in encrypted form, processing passes directly from step S180 to step S182.

At step S182, if the entered current password does not match that stored in the Password field of the appropriate record of the USERS table 42 an audit record of the failed password change attempt is made at step S183 to the ACCESS_FAILURES table 47.

Processing that passes to step S184, where the number of failed login attempts associated with the user is incremented in the USERS table 42. If three failed logins have occurred, (step S185) the user's account is disabled by appropriately setting the Disabled field (step S186) and error message is displayed at step S187 and the system closes at step S188. If the number of failed logins is not equal to three at step S185, processing passes to step S189 where an appropriate error message is displayed. Processing then returns to step S179 where the change password dialog is again displayed to the user.

If, at step S182, the input current password matches that stored in the USERS table 42 of the database, processing passes to step S190, where a check is made to ensure that the new password entered in the New Password textbox 96 matches that entered in the Confirm New Password textbox 97. If the entered passwords do not match, an error message is displayed at step S191, and the user is again presented with the Change Password dialog of FIG. 24 at step S179. If the new password entered in the New Password textbox 96 matches that entered in the Confirm New Password textbox 97, (step S190) processing continues at step S192, where a check is made to determine similarity between the current password, and the new password entered in the New Password textbox 97 and the Confirm New Password textbox 98. The similarity test is intended to ensure that the new password is sufficiently different from the previous password, and such similarity tests will be readily apparent to those of ordinary skill in the art. If the passwords are considered to be too similar, an error message is displayed to the user at step S193, and processing again returns to step S179 where the change password dialog is again displayed. If the passwords are not too similar, processing passes to step S194, where a check is made to ensure that the proposed new password is alphanumeric. If this is not the case, and error message is displayed at step S195, and processing again returns to step S179. Otherwise, processing continues at step S196.

At step S196, the new password is encrypted. At step S197, the encrypted password is stored in the Password field of the user's record in the USERS table 42. The Encrypted field is set to indicate that the password has been encrypted. Additionally, the Password_Expiry_Date is set to the current date, plus sixty days. Step S198 to S202 then ensure that the user is returned to the correct homepage. Step S198 checks if the user is logged in as an assessor, and if this is the case, the assessor homepage is displayed at step S199. Otherwise, processing passes to step S200 where a check is made to determine if the user is logged in as an administrator, in which case the administrator homepage is displayed at step S201. Otherwise, the coordinator homepage is displayed at step S202.

It has been mentioned above that the various homepages provided by the described embodiment of the invention provide a logout button to allow a user to logout. FIG. 25 illustrates the logout process. At step S204 a logout request is made, and at step S205 an appropriate record of the LOGIN_SESSION table 43 is updated to reflect the logout. At step S06 a check is made to determine whether the user is logged in as an assessor. If this is the case, the assessment module downloaded to the user's computer (to allow assessment data to be captured, as described above) is deleted at step 207 before the system terminates at step S208. If the user is not logged in as an assessor, processing passes directly from step S206 to step S208.

Embodiments of the present invention ensure that when a user provides login session information to the controller PC 8, this information is valid. This is illustrated in FIG. 26. At step S209 details of the user's login session (as represented by a record of the LOGIN_SESSION table 43) are provided to the controller PC 8. At step S210, the validity of the provided data is checked in the LOGIN_SESSION table 43 and ASSESSMENT_SESSIONS table 44 of the database. If the data is valid, the system continues at step S211. If however the provided information is invalid, a record of the failed access attempt is stored in the ACCESS_FAILURES table 47 of the database at step S212, Data is stored in the ACCESS_FAILURES table 47 indicating an invalid connection and an associated connection ID. An error message is then displayed at step S213, and the system terminates at step S214.

The described embodiment of the present invention provides an administrator security group, and a user logging in as an administrator is provided with various management functionality over the system, as is now described. FIG. 27 is a flow chart illustrating operation of an administrator homepage provided by the described embodiment of the invention. The homepage is illustrated by step S216, and the user is provided with nine options.

Three options relate to management of users. A create user option provided at step S217, a modify user option provided at step S218, and a delete user option provided at step S219. Three options relate to the management of assessment types. At S220 a new assessment type can be created, at step S221 an existing assessment type can be modified, and at S222 an existing assessment type can be deleted. The administrator home page additionally provides an option at step S223 to modify communications information. At step S224 an administrator can choose to log out of the system, and at step S225 an administrator can choose to modify their own password. The log out and change of password procedures are those which have been described above.

Referring now to FIG. 28, the procedure for creating a user depicted by step S217 of FIG. 27 is described. At step S226 the administrator chooses to create a new user. A create new user dialog 100 (FIG. 29) is then displayed at step S227. The create new user dialog 100 comprises a select user type drop down list 101 which is populated with values from the security groups table 41 of the local database 29. This is used to specify a security group for the new user (e.g. administrator, coordinator or assessor). The create new user dialog 100 further comprises a Username textbox 102 and a text box 103 into which the user's full name can be input. The create new user dialog 100 further comprises a cancel button 104 and a submit button 105. Selection of the cancel button 104 will result in the administrator being returned to the home page at step S216 (FIG. 27).

When appropriate data has been input into the drop down list 101, and the text boxes 102, 103 the submit button 105 is pressed, and the input is received by the controller PC at step S228. At step 229 a check is made to determine whether or not the username input into the Username text box 102 already exists in the USERS table 42 of the local database 29. If the specified username does exist an error message is displayed at S230 and the create new user dialog is again displayed at S227. Assuming that a username not currently present in the USERS table 42 of the local database 29 is input into the user name textbox 102, processing passes to S231 where a new record is created in the USERS table 42 of the local database 29 containing the specified user name, user's full name, and security group for the new user. At S232 a random password for the new user is generated and this generated random password is displayed at step S233. The administrator can then make a note of the randomly generated password and pass this on to the new user, as it will be required for the new user's log on. Processing then passes to step S234 where the generated random password is stored in the Password field of the created record in the USER'S table 42 of the local database 29. Additionally, the expiry date of the randomly generated password (stored in the Password_Expiry_Date field of the USERS table 42) is set to the current date and time to ensure that the user changes their password when they first logon. The new user has then been created, and the administrator home page is again displayed to the user as indicated at step S236 which returns the processing to step S216 of FIG. 27.

If, from the home page schematically depicted by step S216, the user selects to modify a user at Step S218, the processing illustrated in FIG. 30 is carried out. The administrator's selection to modify a user is shown at step S237, and this results in display of a modify user details dialog at step S238. The modified user details dialog 110 is illustrated in FIG. 31. The dialog comprises a user's drop down list 111 which is populated with all user names stored in the USERS table 42 of the local database 29. Selection of a user from the drop down list 111 causes the user's type (i.e. administrator, coordinator, or assessor) to be displayed in the user type drop down list 112. Similarly, the user's full name is displayed in the user's name text box 113. Having selected a user from the drop down list 111, a user can modify the user's type using the drop down list 112 or the user's name using the text box 113. Similarly, selection of the tick box 114 causes the user's password to be reset in the database. When a password is reset the LoginAttempts field of the USERS table is reset to ‘0’. It can be seen from FIG. 31 that the modify user details dialog 110 further comprises a cancel button 115, selection of which returns the administrator to the home page at step S216 of FIG. 27 and a submit button 116 which causes the modification to be stored, as is now described. Referring back to FIG. 30, selection of a user using the drop down list 111 is depicted at step S239, and modification is depicted at step S240. At step S241, the submit button 116 is pressed to cause the modified data to be stored in the USERS table 42 of the local database 29. At step S242 a check is made to determine whether the reset password check box 114 was selected. If the reset password checkbox was not selected processing returns to step S216 of FIG. 27. Otherwise, processing passes from step S242 to step S243 where a new password for the user us randomly generated. At step S244 the randomly generated password is displayed to the administrator, and at step S245 the new Password is stored in the Password filed of the USERS table 42 of the local database 29. At step S246 the users password is set to have an expiry date of the current time (stored in the Password_Expiry_Date field) to force the user to change a password when they next log on. Processing then passes to step S216 of FIG. 27.

FIG. 32 illustrates the processing which takes place when an administrator uses the home page shown as step S216 of FIG. 27 to choose to delete a user. Referring to FIG. 32, at step S247 a request to deactivate a user is received. This results in a deactivate user dialog 120 being displayed at step S248. It can be seen that the deactivate user dialog 120 comprises a drop down list of users 121 which is populated using records of the USERS table 42 of the local database 29. Having selected a user from the users drop down list 121 (step S249) a user can use a submit button 122 to submit the deactivation to the USERS table 42 of the local database 29. It should be noted that the deactivate user dialog 120 further comprises a cancel button 123 selection of which returns the administrator to the home page shown at step S216 of FIG. 27.

Having selected a user to deactivate at step S249, and pressed the submit button 122, the appropriate record of the USERS table 42 of the local database 29 is updated, and more specifically the Disabled field is updated to show that the account has been deactivated at step S250. Having made the appropriate update, the administrator is returned to the home page depicted at step S216 of FIG. 29 at step S251.

Referring back to FIG. 27, the creation, modification and deletion of assessment types is now described.

Referring first to FIG. 34, creation of an assessment type as depicted at step S220 of FIG. 27 is described. At step S252 of FIG. 34, an administrator requests to set up a new assessment type. At step S253 a create new assessment type dialog 125 is displayed. This dialog comprises a Name text box 126 into which an administrator can enter a name for the new assessment type. A path text box 127 is used to specify a file path where details of the new assessment are stored. The text box 127 is not directly editable, but instead a browse button 128 is selected to display a conventional file location window to allow location of an appropriate file. When an appropriate file is located, its path name is inserted into the text box 127. The specified file will provide the program code required to capture assessment data associated with the new assessment type, as described above. The dialog 125 further comprises a cancel button 128 and a submit button 129. Details are entered into the create new assessment dialog 125 at step S254. At step S255 a check is made to determine whether or not the name for the new assessment entered in the text box 126 already exists within the Assessment_Module table 45 of the local database 29. If the name does exists, an error message is displayed at step S256 and processing returns to step S253 where the create new assessment dialog 125 is again displayed to the user and further details can be input. If the input name does not exist in the table, the data input by the user to the create new assessment dialog 125 is stored to the ASSESSMENT_MODULES table 45 of the local database 29 (step S257). A new record will be created to represent the newly created assessment type and a Module_GUID field of this record will be automatically generated. At step S258 the administrator is again presented with the administrator home page depicted by step S216 of FIG. 27.

FIG. 36 illustrates processing which is carried out to modify an assessment type, shown by step S221 of FIG. 27. Referring to FIG. 36 at step S259 an administrator requests to modify an assessment type, resulting in display of an appropriate dialog at step S260. The modification dialog 130 is illustrated in FIG. 37. It can be seen that the dialog comprises an assessment type name drop down list 131 from which an assessment type stored in the ASSESSMENT_MODULES table 45 of the local database 29 can be selected. On selection of one of the assessment types a path text box 132 is populated with data taken from the Local_Path filed of the appropriate record of the ASSESSMENT_MODULES table. The path text box 132 cannot be directly edited, but a browse button 133 can be used to select an alternative file to be associated with the assessment type. The modification dialog 130 further comprises a cancel button 134 and a submit button 135. Referring back to FIG. 36, the modification dialog 130 is used at step S261 to select an assessment type, and at step S262 to modify assessment details. Having modified assessment details, the modify details are saved to the ASSESSMENT_MODULES table 45 of the local database 29 at step S263, and at step S264 the administrator home page depicted by step S216 of FIG. 27 is again displayed to the user.

Referring now to FIG. 38, deletion of an assessment type as illustrated by Step S222 of FIG. 27 as described. At step S265 an administrator will request to delete an assessment type, resulting in display of a delete assessment type dialog at step S266. The delete assessment type dialog is illustrated in FIG. 39. The delete assessment type dialog 140 comprises an Assessment Type drop down list 141 from which an assessment type stored in the ASSESSEMENT_MODULES table 45 of the locate database 29 is selected. A submit button 142 is used to confirm deletion of the assessment type and a cancel button 143 is used to return to the home page depicted at step S216 of FIG. 27.

Referring back to FIG. 38, an assessment type to be deleted is selected at Step S267, and the submit button 142 is selected. At step S268 a check is made to determine whether the selected assessment type has already been used in an assessment session. If this the case, an error message is displayed at step S269 and processing returns to step S266 where a user can again select an assessment type to be deleted. If the selected assessment type has not been used in an assessment session, processing passes to S270 where the appropriate record is deleted from the ASSESSMENT_MODULES table 45 of the local database 29. At step S271 the home page shown as step S216 of FIG. 27 is again displayed.

FIG. 40 illustrates how a communications information can be modified at step S223 of FIG. 27. Referring now to FIG. 40 at step S272 an administrator selects to edit TCP/IP port information on the controller PC 8. At step S273 an appropriate dialog is displayed allowing the user to amend the TCP/IP port number of the controller PC8. This is done at step S274, and at step S275 the appropriate .INI file on the controller PC8 is amended. At step S275 the administrator home page of step S216 of FIG. 27 is again displayed to the administrator.

In the preceding description, it has been explained that the tablet PC's 2, 3, 4 communicate with the controller PC8 using the TCP/IP protocol via the TCP IP modules 34, 36 and 38 of the assessor software 23, and the TCP module 24 of the controller software 22 (FIG. 4). The TCP/IP module are all visual basic modules allowing the various modules of the assessor software 23 and the controller software 22 to open a read/write connection to a TCP/IP socket, listen for connections, and receive and send data. The creation of such visual basic module to carry out TCP/IP communication will be readily apparent to one skilled in the art, and is therefore not described in further detail here.

Table 1 below shows how various commands which need to be communicated between parts of the software illustrated in FIG. 4 communicated using the TCP/IP protocol.

| | | Command | |
|---|---|---|---|
| Command | Description | Used By | Syntax |
| LOGIN | Pass login | Client | LOGIN, <Username>, |
| | information | Module | <Password> |
| CHGPWD | Change | Client | CHGPWD, <Session ID>, <Old |
| | Password | Module, | Password>, <New Password> |
| | | Server | |
| | | Module | |
| LOGOUT | Log the | Client | LOGOUT, <Session ID> |
| | user out of | Module | |
| | the | | |
| | software | | |
| STUDY_NAME | Retrieve | Client | STUDY_NAME |
| | the Study | Module | |
| | Name | | |
| USER_FULL_NAME | Retrieve | Client | USER_FULL_NAME, <Session |
| | users full | Module | ID> |
| | name | | |
| ASSESS_TYPE_NAME | Retrieve | Client | ASSESS_TYPE_NAME |
| | the | Module | |
| | assessment | | |
| | type name | | |
| ASSESS_TYPE_SERVER_URL | Retrieve | Client | ASSESS_TYPE_SERVER_URL |
| | the URL | Module | |
| | for the | | |
| | assessment | | |
| | module | | |
| DL_COMPLETE | Inform | Client | DL_COMPLETE |
| | controller | Module | |
| | assessment | | |
| | download | | |
| | complete | | |
| CONNECT | Establish a | Client | CONNECT, <Session ID> |
| | connection | Module | |
| | to a user | | |
| SCORE | Send a | Client | SCORE, <Score String> |
| | score for an | Module | |
| | image | | |
| START_ASSESSMENT | Inform the | Server | START_ASSESSMENT |
| | client to | Module | |
| | begin | | |
| | assessment | | |
| SCORE_IMAGE | Inform the | Server | SCORE_IMAGE |
| | client to | Module | |
| | display | | |
| | scoring | | |
| | Data Entry | | |
| WAIT | Inform the | Server | WAIT |
| | client to | Module | |
| | hide data | | |
| | entry | | |
| | screen | | |
| END | Inform the | Server | END |
| | client to | Module | |
| | close the | | |
| | assessment | | |
| | module | | |

It has been described above that data is passed from the local database 29 (FIG. 4) to the Oracle Clinical Database stored on the remote database server 12. The Oracle Clinical Database is an Oracle Database. The Oracle Database Management System is a well known SQL database which is available from Oracle Corporation, 500 Oracle Parkway, Redwood Shores Calif. 94065, United States of America. Oracle Clinical is essentially an application which uses an Oracle Database to provide a comprehensive clinical data management solution. The functionality provided by the Oracle Clinical database allows the system as a whole which is described above to satisfy various regulatory requirements, as discussed further below.

Data is transferred from the TEMP_DATA table 40 of the local database 29 at step S62 of FIG. 10 as described above. Data transferred in this way is stored in a table 150 of the Oracle Clinical database which is illustrated in FIG. 41. Writing of data to the table 150 involves committing data to the table 150 in a conventional manner. A PT field is used to store an identifier of a patient whose scar was used to generate the image which is assessed by the assessment data. This data can be generated by the controller PC 8 by ensuring that the Image_Number field of the TEMP_DATA table 40 provides data which can be interpreted in a predetermined manner to extract an identifier for a patient.

An ASSR field of the table 150 is used to identifier an assessor who contributed the assessment data represented by a particular record. An ATYPE field of the table 150 is used to identify the type of assessment data represented by a particular record of the table (e.g. Type I or Type II assessment as described above). This data is taken from the Assessment_Type field of the TEMP_DATA table 40. An IMGID field is used to identify the image and this data is taken from the Image_Number field of the TEMP_DATA table 40. An IMGTYP field is used to identify whether the image was taken from the “batch 1” folder or “batch 2” folder of the controller PC 8. Again, by ensuring that each entry of the Image_Number field of the TEMP_DATA table 40 can be interpreted to derive a folder name, data for the IMGTYP field can be generated.

VALUE1, VALUE2, and DIFF fields together represent assessment data. The VALUE1 field corresponds to the Value_{—}1 field of the TEMP_DATA table 40. That is, where visual analogue scoring data is stored, this field stores a real number indicating that score. Where comparative scoring data is stored, this field stores a value of ‘0’ to indicate that images show scarring of equal severity, a value of ‘1’ to indicate that a first image shows less severe scarring than a second image, and a value of ‘2’ to indicate that the second image shows less severe scarring that the first image. Similarly the DIFF field corresponds to the Difference field of the TEMP_DATA table 40. This field is therefore used only for comparative scoring. A value of ‘0’ indicates that there is no difference in severity of scarring, a value of ‘1’ indicates a slight difference and a value of ‘2’ indicates an obvious difference. The VALUE2 field is not used for collection of assessment data as described above. However, the inclusion of this field allows different types of assessment data to be collected in which a greater quantity of data needs to be stored in the table 150.

It should be noted that the PT field of the table 150 references a further table of the Oracle Clinical database which contains details of patients. Thus, in order for data for a particular patient to be stored in the table 150 a record identifying that patient must be present in the further table of the database.

It will be appreciated that data stored in the table 150 can be queried and used to generate reports. A generic Oracle Open Database Connectivity (ODBC) driver allows data to be read from the table 150.

It was described above that heretofore there was no system which allowed data relating to images to be collected which complied with the requirements of 21 CFR Part 11 (referenced above). The system described above does satisfy these requirements, and the manner in which the system satisfies the various requirements is now described.

The way in which data is stored is strictly specified by 21 CFR Part 11. It is required that any storage system allows accurate and complete copies of records to be created in human readable and electronic form, such that records can be inspected by the Food and Drug Administration (FDA). Given that collected data is passed to an Oracle Clinical database which provides such functionality, this requirement is met. Similarly, requirements relating to protection of records, provision of an audit trail and storage of previous versions of records are all provided by the Oracle Clinical database. Additionally, 21 CFR Part 11 requires that a timestamped audit trail of collected data can be generated. By storing data indicative of times at which data is collected (as set out above), and forwarding this data to the Oracle Clinical Database, this requirement is satisfied.

21 CFR Part 11 further requires that access to the system is controlled, and as described above the described system uses user names and passwords to ensure that only authorised users are allowed to access the system. Similarly, there is a requirement that passwords must be reset at predetermined time intervals, and this has been described above. Features such as locking of user accounts after three unsuccessful login attempts and storing data representing these failed logins also provide required security. Additionally various features have been described which ensure that only authorised terminals are able to provide assessment data as is requirement by 21 CFR Part 11.

21 CFR Part 11 also requires that data collection is carried out in a well defined manner. By specifying and enforcing a sequence of actions as described above this requirement is satisfied. Therefore, the described embodiment of the present invention allows data to be collected in a manner conforming to the requirements of 21 CFR Part 11.

Preferred embodiments of the present invention have been described above. However, it will be readily apparent to one skilled in the art that various modifications can be made to the described embodiments without departing from the spirit and scope of the present invention as defined by the appended claims. For example, it will be readily apparent that although only three tablet PC's 2, 3, 4 are illustrated in FIG. 1 in some embodiments of the present invention a larger number of tablet PCs may be used. Similarly, where references have been made to particular databases and programming languages and operating systems, it will be readily apparent to one of ordinary skill in the art that other suitable programming languages, databases and operating systems may be used in alternative embodiments of the present invention.

1. A method of collecting information relating to an image, the method comprising:
presenting the image;
receiving at a server a plurality of data items relating to said image each of said data items being received from one of a plurality of computers;
associating said data items with an identifier identifying said image at said server; and
storing each data item together with the associated identifier in a data repository.

2. A method according to claim 1, further comprising:
transmitting to each of said plurality of computers a request for a data item relating to said image;
wherein said receiving said plurality of data item comprises receiving said plurality of data items in response to said request.

3. A method according to claim 2, wherein said request is transmitted at a first time, and said plurality of data items are received within a predetermined time period beginning at said first time.

4. A method according to claim 3, wherein said request transmits said predetermined time period to said plurality of computers.

5. A method according to claim 2, wherein said request is configured to cause each of said plurality of computers to display a user interface configured to generate a data item.

6. A method according to claim 5, wherein said request is configured to cause each of said plurality of computers to display said user interface for a predetermined time period.

7. A method according to claim 1, wherein each of said data items represents a subjective user response to said image.

8. A method according to claim 1, wherein said image is an image of human or animal skin.

9. A method according to claim 8, wherein said image is an image of human or animal skin including a scar.

10. A method according to claim 9, wherein each of said data items comprises a real number within a predetermined range.

11. A method according to claim 10, wherein said real number represents perceived severity of said scar on a predetermined scale.

12. A method according to claim 10, wherein said real number is generated using a visual analogue scoring method.

13. A method according to claim 1, wherein said image is a plurality of images.

14. A method according to claim 13, wherein each of said data items represents a comparison between said plurality of images.

15. A method according to claim 14, wherein each image of said plurality of images is an image of a scar.

16. A method according to claim 15, wherein each of said data items indicates whether there is a perceived difference in severity of scarring shown by said plurality of images.

17. A method according to claim 16, wherein if one of said data item indicates that there is a perceived difference in severity of scarring, said one data item further indicates which of said images shows least severe scarring.

18. A method according to claim 17, wherein said one data item further specifies an order for said plurality of images, based upon severity of scarring shown by the images.

19. A method according to claim 16, wherein if said one data item indicates that there is a perceived difference between the severity of scarring, said data item further indicates a degree of said difference.

20. A method according to claim 13, wherein said plurality of images is a pair of images.

21. A method according to claim 1, further comprising:
providing computer program code to each of said plurality of computers, said program code being executable at one of said plurality of computers to generate one of said data items.

22. A method according to claim 21, wherein said program code is provided to said plurality of computers by said server.

23. A method according to claim 21, wherein said computer program code includes computer program code executable to provide an interface to control data collection to generate one of said data items.

24. A method according to claim 1 further comprising: storing data defining a plurality of users, said data including a username and password for each of said plurality of users.

25. A method according to claim 1 further comprising:
storing data indicating a number of user logons which are required to allow information collection.

26. A method according to claim 25, further comprising:
receiving user input specifying said required number of logons.

27. A method according to claim 25, further comprising, before presentation of said image:
receiving a logon request, said logon request being received from one of said plurality of computers, and including a username and password;
validating said received logon request using said data defining a plurality of users; and
generating data indicating a logon if but only if said validation is successful.

28. A method according to claim 27, further comprising, before presentation of said image:
receiving at least as many logon requests as said required number of logons, and generating data indicating said required number of logons.

29. A method according to claim 27, further comprising:
denying said logon request if said required number of users are logged on.

30. A method according to claim 1, further comprising:
presenting said image for not longer than a maximum image presentation time.

31. A method according to claim 30, further comprising:
receiving user input specifying said maximum image presentation time.

32. A method according to claim 30, further comprising:
before presentation of said image, receiving at least as many logon requests as said required number of logons, and generating data indicating said required number of logons; and
presenting said image either for the maximum image presentation time or until a data item associated with each of said logons has been received.

33. A method according to claim 30, further comprising:
if a data item associated with one of said logons has not been received when said maximum presentation time is reached, generating data indicating each of said logons for which data has not been received, and said image.

34. A method according to claim 33, further comprising:
representing said image; and
receiving a data item associated with each of said indicated logons.

35. A method according preceding claim 1, wherein presenting said image comprises displaying said image using a projector.

36. A method according preceding claim 1, wherein each said plurality of data items is received from a remote computer.

37. A method according to claim 36, wherein each of said plurality of data items is received using the TCP/IP protocol.

38. A method according to claim 1, wherein storing each data item with its associated identifier in a database further comprises:
storing with each data item a date and time at which it was received;

39. A method according to claim 1, wherein storing each data item with its associated identifier in a database further comprises:
storing with each data item data indicating a user logon at the computer providing said data item.

40. A method according to claim 1, further comprising:
transmitting each of said data items together with the associated identifier to a remote data repository.

41. A method according to claim 1, further comprising:
sequentially presenting a plurality of images; and
receiving a plurality of data items relating to each of said plurality of images.

42. A method according to claim 41, wherein sequentially presenting said plurality of images, comprises sequentially presenting said plurality of images in a random or pseudo random order.

43. A method according to claim 42, wherein said random or pseudo random order is selected from one or more previously used random or pseudo random orders.

44. A method according a claim 43 wherein a user is presented with an option of using a previously used random or pseudo random order, or generating a new random or pseudo random order.

45. A method according to claim 41, wherein some of said plurality of images are identical.

46. A method according to claim 41, further comprising:
generating a report indicating user logons for which data items have not been received.

47. A method according to claim 46, wherein for each user logon said report indicates images for which a data item has not been received.

48. A method according to claim 47, further comprising:
displaying each image for which data has not been received from all user logons; and
receiving a data item relating to each displayed image from the or each user logon from which data has not previously been received.

49. A data carrier carrying computer readable instructions for controlling a computer to carry out the method of claim 1.

50. A computer apparatus comprising:
a program memory storing processor readable instructions; and
a processor configured to read and execute instructions stored in said program memory;
wherein said processor readable instructions comprise instructions controlling the processor to carry out the method of claim 1.

51. A method of collecting information relating to an image, the method comprising:
presenting the image from a first computer;
generating a plurality of data items relating to said image, each of said data items being generated by one of a plurality of second computers connected to said first computer;
transmitting each of said data items from a respective one of the plurality of second computers to the first computer;
receiving each of said data items at the first computer;
associating said data items with an identifier identifying said image at said first computer; and
storing each data item together with the associated identifier in a data repository.

52. A method according to claim 51, further comprising:
transmitting to each of said plurality of second computers a request for a data item relating to said image;
wherein said receiving said plurality of data item comprises receiving said plurality of data items in response to said request.

53. A method according to claim 52, wherein said request is transmitted at a first time, and said plurality of data items are received within a predetermined time period beginning at said first time.

54. A method according to claim 53, wherein said request transmits said predetermined time period to said plurality of said computers.

55. A method according to claim 52, wherein said request is configured to cause each of said plurality of second computers to display a user interface configured to generate a data item.

56. A method according to claim 55, wherein said request is configured to cause each of said plurality of second computers to display said user interface for a predetermined time period.

57. A method according to claim 51, wherein each of said data items represents a subjective user response to said image.

58. A method according to claim 51, wherein said image is an image of human or animal skin.

59. A method according to claim 58, wherein said image is an image of human or animal skin including a scar.

60. A method according to claim 59, wherein each of said data items comprises a real number within a predetermined range.

61. A method according to claim 60, wherein said real number represents perceived severity of said scar on a predetermined scale.

62. A method according to claim 60, wherein said real number is generated using a visual analogue scoring method.

63. A method according to claim 62, further comprising:
presenting a user interface on a display device of each of said second computers, said user interface comprising a scale; and
receiving input data indicative of user input of a point on said scale.

64. A method according to claim 63, further comprising: converting said user input from a point on said scale to said real number.

65. A method according to claim 64, wherein said converting is carried out at a respective second computer.

67. A method according to claim 64, wherein said converting comprises:
defining a first real number value corresponding to a first end of said scale;
defining a second real number value corresponding to a second end of scale;
computing a distance from said first end of said scale to said point;
converting said distance to a real value on the basis of the distance between said first and second ends, and said first and second real number values.

68. A method according claim 62 further comprising:
transmitting computer program code from said first computer to each of said second computers; and
receiving said program code at each of said second computers;
wherein said computer program code is executable on each of said second computers to cause said user interface to be displayed.

69. A method according to claim 68, wherein said converting is carried out at a respective second computer, and said computer program code is configured to carry out said converting.

70. A method according to claim 51, wherein said image is a plurality of images.

71. A method according to claim 70, wherein each of said data items represents a comparison between said plurality of images.

72. A method according to claim 71, wherein each image of said plurality of images is an image of a scar.

73. A method according to claim 72, wherein each of said data item indicates whether there is a perceived difference in severity of scarring shown by said plurality of images.

74. A method according to claim 73, wherein if one of said data items indicates that there is a perceived difference in severity of scarring, said one data item further indicates which of said images shows least severe scarring.

75. A method according to claim 71, further comprising:
presenting a user interface on a display device of each of said second computers, said user interface including a plurality of user selectable buttons; and
receiving input data indicative of user selection of one of said buttons.

76. A method according to claim 75, wherein said plurality of images is a pair of images.

77. A method according to claim 76, wherein said interface comprises three buttons, a first button being selectable to indicate that a first image of said pair of images shows less severe scarring, a second button being selectable to indicate that a second image of said pair of images shows less severe scarring, and a third button be selectable to indicate that said first and second images show scarring of similar severity.

78. A method according to claim 77, further comprising:
receiving at one of said second computers input data indicative of user selection of said first button or said second button; and
displaying a further user interface on the display device of said one of said second computers.

79. A method according to claim 78, wherein said further user interface is configured to receive input data indicative of a degree of difference between severity of scarring shown in said first and second images of said pair of images.

80. A method according to claim 79, wherein said further user interface presents a pair of buttons, a first button indicating that said difference is slight, and a second button indicating that said difference is marked.

81. A method according to claim 80, wherein one of said data items indicates said degree of difference.

82. A method according to claim 51, further comprising:
transmitting computer program code from said first computer to each of said second of computers, said program code being executable to generate one of said data items at said second computers.

83. A method according to claim 82, wherein said computer program code includes computer program code executable to provide an interface to control data collection to generate one of said data items.

84. A method according to claim 51 further comprising:
storing on the first computer data defining a plurality of users, said data including a username and password for each of said plurality of users.

85. A method according to claim 84, further comprising:
storing data on the first computer indicating a number of user logons which are required to allow information collection.

86. A method according to claim 84, further comprising, before presentation of said image:
receiving a logon request at the first computer from one of said second computers, said logon request including a username and password;
validating said received logon request at said first computer using said data defining a plurality of users;
transmitting data to said one of said second computers indicating success or failure of said validation; and
generating data indicating a logon if but only if said validation is successful.

87. A method according to claim 86, further comprising, before presentation of said image:
receiving at the first computer from said second computers at least as many logon requests as said required number of logons, and generating data indicating said required number of logons.

88. A method according to claim 51, further comprising:
presenting said image for not longer than a maximum image presentation time.

89. A method according to claim 88, further comprising:
receiving at the first computer user input specifying said maximum image presentation time.

90. A method according to claim 88, further comprising:
presenting said image either for the maximum image presentation time or until a data item associated with each of said logons has been received.

91. A method according to claim 88, further comprising:
if a data item associated with one of said logons has not been received when said maximum presentation time is reached, generating data indicating each of said logons for which data has not been received, and said image.

92. A method according to claim 91, further comprising:
representing said image; and
receiving a data item associated with each of said indicated logons.

93. A method according to claim 92, further comprising:
presenting a user interface for collection of said data item only on second computers corresponding to said indicated login.

94. A method according to claim 51, further comprising:
transmitting each of said data items together with the associated identifier to a remote data repository server.

95. A method according to claim 51, further comprising:
sequentially presenting a plurality of images from said first computer, and
receiving a plurality of data items relating to each of said plurality of images.

96. A data carrier carrying computer readable instructions for controlling a computer to carry out the method of claim 51.

97. A computer apparatus comprising:
a program memory storing processor readable instructions; and
a processor configured to read and execute instructions stored in said program memory;
wherein said processor readable instructions comprise instructions controlling the processor to carry out the method of claim 51.

98. A method of collecting information relating to an image, the method comprising:
generating a data item relating to a displayed image at a second computer, and
transmitting said data item from said second computer to a first computer; wherein said first computer is configured to display said image, to receive said data item from said second computer, to receive at least one further data item from at least one further second computer, to associate said data items with an identifier identifying said image, and to store each data item together with the associated identifier in a data repository.

99. A method according to claim 98, further comprising:
receiving a request for a data item relating to said image;
wherein transmitting said data item comprises transmitting said data item in response to said request.

100. A method according to claim 99, wherein said request is received at a first time, and said data item is transmitted within a predetermined time period beginning at said first time.

101. A method according to claim 100, wherein said request specifies said predetermined time period.

102. A method according to claim 99, wherein said request is configured to cause said second computer to display a user interface configured to generate a data item.

103. A method according to claim 102, wherein said request is configured to cause said computer to display said user interface for a predetermined time period.

104. A method according to claim 98, wherein said image is an image of human or animal skin.

105. A method according to claim 104, wherein said image is an image of human or animal skin including a scar.

106. A method according to claim 105, wherein said generated data item comprises a real number within a predetermined range.

107. A method according to claim 106, wherein said real number represents perceived severity of said scar on a predetermined scale.

108. A method according to claim 106, wherein said real number is generated using a visual analogue scoring method.

109. A method according to claim 108, further comprising:
presenting a user interface on a display device of said second computer, said user interface comprising a scale; and
receiving input data indicative of user input of a point on said scale.

110. A method according to claim 109, further comprising:
converting said user input from a point on said scale to said real number.

111. A method according to claim 110 further comprising:
receiving computer program code at said second computer, said computer program code being executable on said second computer to cause said user interface to be displayed.

112. A method according to claim 111, wherein said computer program code is configured to carry out said converting.

113. A method according to claim 98, wherein said image is a plurality of images, and said generated data item represents a comparison between said plurality of images.

114. A method according to claim 113, wherein each image of said plurality of images is an image of a scar.

115. A method according to claim 114, wherein said generated data item indicates whether there is a perceived difference in severity of scarring shown by said plurality of images.

116. A method according to claim 115, wherein if said generated data item indicates that there is a perceived difference severity of scarring, said one data item further indicates which of said images shows least severe scarring.

117. A method according to claim 113, further comprising:
presenting a user interface on a display device of said second computer, said user interface including a plurality of user selectable buttons; and
receiving input data indicative of user selection of one of said buttons.

118. A method according to claim 117, wherein said plurality of images is a pair of images.

119. A method according to claim 118, wherein said user interface comprises three buttons, a first button being selectable to indicate that a first image of said pair of images shows less severe scarring, a second button being selectable to indicate that a second image of said pair of images shows less severe scarring, and a third button be selectable to indicate that said first and second images show scarring of similar severity.

120. A method according to claim 119, further comprising:
receiving input data indicative of user selection of said first button or said second button; and
displaying a further user interface on the display device of said second computer.

121. A method according to claim 120, wherein said further user interface is configured to receive input data indicative of a degree of difference between severity of scarring shown in said first and second images of said pair of images.

122. A method according to claim 121, wherein said further user interface presents a pair of buttons, a first button indicating that said difference is slight, and a second button indicating that said difference is marked.

123. A method according to claim 122, wherein one of said data items indicates said degree of difference.

124. A method according to claim 98, further comprising:
receiving computer program code at said second computer, said program code being configured to generate one of said data items at said second computer.

125. A method according to claim 124, wherein said computer program code includes computer program code executable to provide an interface to control data collection to generate one of said data items.

126. A data carrier carrying computer readable instructions for controlling a computer to carry out the method of claim 98.

127. A computer apparatus comprising:
a program memory storing processor readable instructions; and
a processor configured to read and execute instructions stored in said program memory;
wherein said processor readable instructions comprise instructions controlling the processor to carry out the method of claim 98.

128. A system for collecting information relating to an image, the system comprising a first computer in communication with a plurality of second computers wherein:
the first computer is configured to present the image,
each of the second computers is configured to capture a data item relating to the image and to transmit said data item to said first computer; and
the first computer is configured to receive said data items, to associate an identifier identifying said image with each data item, and to output each data item together with the associated identifier to a data repository.

129. A system according to claim 128, further comprising a database server connected to said first computer.

130. A system according to claim 129, wherein said first computer is further configured to transmit said data items together with the associated identifier to the database server.

131. A system according to claim 129, wherein said communication between said first computer and said database server is a wired connection or a wireless connection.

132. A method for collecting data representing an assessment of scarring displayed in an image, the method comprising:
presenting said image;
receiving a plurality of data items relating to said image, each of said data items being received from one of a plurality of computers, and each data item representing an assessment of scarring displayed in the image associating said data items with an identifier identifying said image; and
storing each data item together with the associated identifier in a database.

133. A method for collecting assessment data relating to displayed data, the method comprising:
providing computer program code to a plurality of second computers, said computer program code being executable at each of said second computers to control collection of said assessment data;
presenting said displayed data; and
receiving assessment data relating to said displayed data from each of said plurality of second computers, said assessment data being generated at each of said second computers by execution of said computer program code.

134. A method according to claim 133 wherein said displayed data is image data.

135. A method according to claim 133, wherein said computer program code is executable to display a user interface configured to receive user input to generate one of said data items.

136. A method according to claim 133, further comprising:
storing a plurality of computer programs, each computer program being defined by respective computer program code; and
receiving user input indicating selection of one of said computer programs; wherein said providing computer program code comprises providing computer program code defining said selected computer program.

137. A data carrier carrying computer readable instructions for controlling a computer to carry out the method of claim 133.

138. A computer apparatus comprising:
a program memory storing processor readable instructions; and
a processor configured to read and execute instructions stored in said program memory;
wherein said processor readable instructions comprise instructions controlling the processor to carry out the method of claim 133.

139. Apparatus for collecting information relating to an image, the apparatus comprising:
display means configured to present the image;
receiving means configured to receive a plurality of data items relating to said image from one of a plurality of computers;
processor means configured to associate said data items with an identifier identifying said image; and
storage means configured to store each data item together with the associated identifier in a data repository.

140. Apparatus for collecting information relating to an image, the apparatus comprising:
processing means configured to generate a data item relating to a displayed image, and
transmitting means configured to transmit said data item to a first computer, wherein said first computer is configured to display said image, to receive said data item from said second computer, to receive at least one further data item from at least one further second computer to associate said data items with an identifier identifying said image, and to store each data item together with the associated identifier in a data repository.

141. A method of collecting information relating to an image, the method comprising:
presenting the image;
transmitting to each of a plurality of computers a request for a data item relating to said image;
receiving at a server a plurality of data items relating to said image, each of said data items being received from one of a plurality of computers, and each of said data items being received in response to said request;
associating said data items with an identifier identifying said image at said server; and
storing each data item together with the associated identifier in a data repository.

142. A method of collecting information relating to an image, the method comprising:
presenting the image for a predetermined time period;
transmitting a request to each of a plurality of computers for a data item relating to said image;
receiving a plurality of data items relating to said image, each of said data items being received from one of a plurality of computers, and each of said data items being received within said predetermined time period;
associating said received data items with an identifier identifying said image; and
storing each data item together with the associated identifier in a data repository.

143. A method according to claim 142 wherein data items are received from only a subset of said plurality of computers to which said request was transmitted in said predetermined time period, and data items are subsequently received from other computers of said plurality of computers.
